(19) United States
(12) Patent Application Publication
(10) Pub. No.: US 2025/0351172 A1
(43) Pub. Date: Nov. 13, 2025

(54) COORDINATED CHANNEL ACCESS BETWEEN WIRELESS ACCESS POINTS (APS)

(71) Applicant: QUALCOMM Incorporated, San Diego, CA (US)

(72) Inventors: Giovanni CHISCI, San Diego, CA (US); Abhishek Pramod PATIL, San Diego, CA (US); Alfred ASTERJADHI, San Diego, CA (US); Sanket Sanjay KALAMKAR, San Diego, CA (US); Sherief HELWA, San Diego, CA (US); Gaurang NAIK, San Diego, CA (US); George CHERIAN, San Diego, CA (US)

(21) Appl. No.: 18/658,955

(22) Filed: May 8, 2024

(51) Int. Cl. H04W 74/0816; H04W 74/08; H04W 76/19

(52) U.S. Cl. CPC H04W 74/0816; H04W 74/0866; H04W 76/19

(57) ABSTRACT

This disclosure provides methods, components, devices and systems for coordinated channel access between wireless access points (APs). Some aspects more specifically relate to mechanisms according to which a first AP provides prioritized channel access for a second AP across various scenarios, including scenarios in which the first AP has an ongoing channel access procedure at a beginning of a coordinated time region of the second AP. The coordinated time region of the second AP may be associated with a first set of channel access parameters. In accordance with initiating a first channel access procedure prior to the coordinated time region in accordance with a second set of channel access parameters different than the first set of channel access parameters, the first AP may interrupt the first channel access procedure at or prior to the beginning of the coordinated time region.

### TECHNICAL FIELD

This disclosure relates generally to wireless communication and, more specifically, to coordinated channel access between wireless access points (APs).

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a first wireless access point (AP). The first wireless AP may include a processing system that includes processor circuitry and memory circuitry that stores code. The processing system may be configured to cause the first wireless AP to receive information indicative of a coordinated time region associated with a second wireless AP and a first set of channel access parameters associated with the coordinated time region and transmit a frame within a transmission opportunity (TXOP) obtained in accordance with a first channel access procedure or a second channel access procedure in association with interrupting the first channel access procedure at or prior to a beginning of the coordinated time region, where the first channel access procedure is in accordance with a second set of channel access parameters different than the first set of channel access parameters.

Another innovative aspect of the subject matter described in this disclosure can be implemented in a method for wireless communication by or at a first wireless AP. The method may include receiving information indicative of a coordinated time region associated with a second wireless AP and a first set of channel access parameters associated with the coordinated time region and transmitting a frame within a TXOP obtained in accordance with a first channel access procedure or a second channel access procedure in association with interrupting the first channel access procedure at or prior to a beginning of the coordinated time region, where the first channel access procedure is in accordance with a second set of channel access parameters different than the first set of channel access parameters.

Another innovative aspect of the subject matter described in this disclosure can be implemented in a first wireless AP. The first wireless AP may include means for receiving information indicative of a coordinated time region associated with a second wireless AP and a first set of channel access parameters associated with the coordinated time region and means for transmitting a frame within a TXOP obtained in accordance with a first channel access procedure or a second channel access procedure in association with interrupting the first channel access procedure at or prior to a beginning of the coordinated time region, where the first channel access procedure is in accordance with a second set of channel access parameters different than the first set of channel access parameters.

Another innovative aspect of the subject matter described in this disclosure can be implemented in a non-transitory computer-readable medium storing code for wireless communication by a first wireless AP. The code may include instructions executable by a processing system (including one or more processors) to (cause the first wireless AP to) receive information indicative of a coordinated time region associated with a second wireless AP and a first set of channel access parameters associated with the coordinated time region and transmit a frame within a TXOP obtained in accordance with a first channel access procedure or a second channel access procedure in association with interrupting the first channel access procedure at or prior to a beginning of the coordinated time region, where the first channel access procedure is in accordance with a second set of channel access parameters different than the first set of channel access parameters.

Some implementations of the method, first wireless APs, and non-transitory computer-readable medium described herein may further include operations, features, means, or instructions for initiating the first channel access procedure in accordance with the second set of channel access parameters prior to the beginning of the coordinated time region, where interrupting the first channel access procedure at or prior to the beginning of the coordinated time region may be in association with initiating the first channel access procedure in accordance with the second set of channel access parameters prior to the beginning of the coordinated time region and the coordinated time region being associated with the first set of channel access parameters.

In some implementations of the method, first wireless APs, and non-transitory computer-readable medium described herein, the first wireless AP classifies the beginning of the coordinated time region as a channel busy event and interrupts the first channel access procedure at or prior to the beginning of the coordinated time region in association with classifying the beginning of the coordinated time region as the channel busy event and interrupting the first channel access procedure includes pausing the first channel access procedure.

Some implementations of the method, first wireless APs, and non-transitory computer-readable medium described herein may further include operations, features, means, or instructions for initiating the second channel access procedure in accordance with the first set of channel access parameters within the coordinated time region in association with interrupting the first channel access procedure at or prior to the beginning of the coordinated time region.

In some implementations of the method, first wireless APs, and non-transitory computer-readable medium described herein, in accordance with a rule associated with the coordinated time region, the first wireless AP refrains from performing a channel access procedure within at least a portion of the coordinated time region.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example communication timeline that supports coordinated channel access between wireless access points (APs).

FIG. 3 shows an example signaling diagram that supports coordinated channel access between wireless APs.

FIG. 4 shows example communication timelines that support coordinated channel access between wireless APs.

FIG. 5 shows a block diagram of an example wireless communication device that supports coordinated channel access between wireless APs.

FIGS. 6-9 show flowcharts illustrating example processes performable by or at a first wireless AP that support coordinated channel access between wireless APs.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, multiple access points (APs) may be located within a relatively close proximity of each other, each AP of the multiple APs organizing communication to and from a respective set of associated stations (STAs). In some scenarios, an AP may participate in a communication (such as a transmission or reception) of periodic (or relatively periodic) data traffic. In such scenarios, the AP may schedule a set of (periodic) time regions for the data traffic. For example, the AP may schedule a set of time regions for communication of the data traffic between the AP and an associated STA. If the communication with the STA is relatively high priority or latency-sensitive, the AP may attempt to protect the set of time regions from other, potentially interfering communications by other wireless communication devices operating on a same or nearby channel. For example, the AP and one or more other APs operating on a same channel may coordinate their respective communication schedules, such that the time regions scheduled by the AP avoid overlapping with, for example, time regions scheduled by another AP. The set of APs operating on the same channel also may employ a mechanism to enable the set of APs to extend the protection of a communication schedule of an AP. For example, a first AP may broadcast information indicative of the time regions scheduled by a second AP (such that STAs associated the first AP also avoid interfering with the time regions scheduled by the second AP). By way of such inter-AP coordination, a time region scheduled by an AP may be understood as a coordinated time region.

An AP also may indicate one or more channel access parameters that other APs may use to attempt to obtain channel access within a coordinated time region. For example, a first AP may receive an indication of a set of channel access parameters to use within a coordinated time region of a second AP. Such indicated channel access parameters may be deprioritized channel access parameters relative to the channel access parameters that the second AP uses within the coordinated time region (and also relative to the channel access parameters that the first AP otherwise uses outside of the coordinated time region), which may prioritize channel access for the second AP and facilitate low-latency channel access for latency-sensitive or high priority traffic. Some wireless communication networks, however, may lack mechanisms according to which the first AP is to apply an indicated set of channel access parameters associated with a coordinated time region. For example, the first AP may experience a variety of scenarios leading up to and during a coordinated time region and some networks may lack mechanisms according to which the first AP is able to reliably use the channel access parameters indicated by the second AP (without unnecessarily impacting communication protocols at the first AP in a non-mutually understood way).

Various aspects relate generally to coordinated channel access between the first AP and the second AP. Some aspects more specifically relate to one or more mechanisms or protocols according to which the first AP may provide prioritized channel access for the second AP across various scenarios, including scenarios in which the first AP has an ongoing channel access procedure at (or near) a beginning of a coordinated time region of the second AP. For example, the first AP may receive (such as obtain, derive or determine) an indication of the coordinated time region of the second AP and an indication of a first set of channel access parameters associated with (such as to use within) the coordinated time region. In accordance with some example implementations, if the first AP initiates (such as starts, invokes, or begins) a first channel access procedure prior to the coordinated time region in accordance with a second set of channel access parameters (such as a set of channel access parameters that the first AP uses outside of coordinated time regions), the first AP may interrupt the first channel access procedure at or prior to the beginning of the coordinated time region. In such implementations, the first AP may attempt to obtain a transmission opportunity (TXOP) in association with resuming the first channel access procedure post-interruption or in association with initiating a second channel access procedure.

In some examples, the first AP may pause or terminate the first channel access procedure and initiate a second channel access procedure in accordance with the first set of channel access parameters within the coordinated time region. In examples in which the first AP pauses the first channel access procedure, the first AP may store a state associated with the first channel access procedure and resume the first channel access procedure after the coordinated time region using the stored state. In examples in which the first AP terminates the first channel access procedure, the first AP may discard a state associated with the first channel access procedure. Additionally, or alternatively, the first AP may classify the beginning of the coordinated time region as a (virtual) channel busy event and pause the first channel access procedure for at least a threshold time duration. In such examples, the first AP may resume the first channel access procedure within the coordinated time region or after the coordinated time region in accordance with detecting an idle channel for the threshold time duration. The threshold time duration may span a portion of the coordinated time region, an entirety (such as a full duration) of the coordinated time region, or a duration that is longer than the coordinated time region.

Additionally, or alternatively, the first AP may classify a portion or an entirety of the coordinated time region as a (virtual) channel busy event and pause or terminate the first channel access procedure at or prior to the beginning of the coordinated time region. In examples in which the first AP pauses the first channel access procedure, the first AP may store a state associated with the first channel access procedure and resume the first channel access procedure after the channel busy event using the stored state. In examples in which the first AP terminates the first channel access procedure, the first AP may initiate a second channel access procedure in accordance with the first set of channel access parameters (if a portion of the coordinated time region is classified as the channel busy event) or in accordance with the second set of channel access parameters (if an entirety of the coordinated time region is classified as the channel busy event).

Particular aspects of the subject matter described in this disclosure can be implemented to realize one or more of the following potential advantages. In some examples, by supporting one or more of the example mechanisms disclosed herein, the first AP and the second AP may achieve greater synchronization regarding operation at the first AP, which may provide greater negotiation capabilities (such as a more informed negotiation between the first AP and the second AP) and more suitable resulting coordinated communication schedules. Such communication schedules may balance protection for the second AP with operational impact at the first AP. For example, in accordance with mechanisms according to which the first AP interrupts an ongoing channel access procedure and initiates a new channel access procedure within the coordinated time region, the first AP may offer strong compliance with the channel access parameters indicated by the second AP, which may increase a likelihood of efficient and low-latency communication at the second AP.

Further, in accordance with mechanisms according to which the first AP pauses an ongoing channel access procedure and resumes the channel access procedure within or after the coordinated time region, the first AP may offer the second AP a configurable amount of prioritization without starting a new channel access procedure. For example, the second AP may indicate, set, or configure a threshold time duration for which the first AP may be expected to detect an idle channel prior to being able to resume the channel access procedure. Such mechanisms may balance compliance by the first AP with a relatively lower operational impact (and relatively lower processing complexity) at the first AP. Moreover, in accordance with mechanisms according to which the first AP classifies a portion or an entirety of the coordinated time region as a channel busy event, the first AP may offer reduced (such as zero) competition for channel access for a configurable amount of time while also experiencing a relatively lower operational impact. By way of such greater inter-AP coordination and the achieved efficient and low latency signaling, the described techniques may be further implemented to realize more efficient use of processing resources, higher throughput, greater network capacity, and greater spectral efficiency, among other benefits.

Additionally, in some implementations, multiple APs may leverage such greater inter-AP coordination to more fully utilize and achieve benefits of other coordination schemes, such as one or more of coordinated TDMA (C-TDMA), coordinated spatial reuse (C-SR), and coordinated beamforming (C-BF). In accordance with C-TDMA, a first AP and a second AP may exchange frames such that the first AP (a controller of a TXOP) may share a TXOP with the second AP. In this way, the first AP may serve latency traffic via a first portion of the TXOP and may provide the second AP a clear shared TXOP (such as a TXOP free of interference from the first AP and, in some examples, client devices associated with the first AP). In accordance with C-SR, a first AP and a second AP may exchange frames to determine that spatial reuse (such as concurrent medium use) is associated with a tolerable amount of interference (such as less than a threshold amount of interference). By determining that concurrent medium use is associated with the tolerable amount of interference, the first AP and the second AP may communicate simultaneously to achieve higher data rates and greater system capacity. Thus, agreements for coordinated time regions may provide benefits to the AP associated with (that controls) the time region and also may provide opportunities for frame exchange (for further coordination) between APs. For example, a first AP may obtain information indicative of one or more times at which a second AP is interested in accessing a channel and may enter a receiving state to monitor for coordination information (for C-TDMA, C-SR, or C-BF) at the one or more times. Through such coordination, various wireless communication devices may achieve lower latency, greater throughput, and improved tail performance.

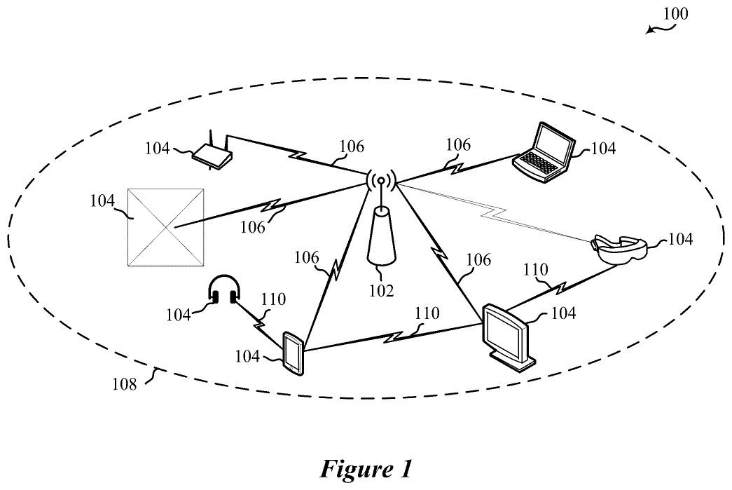

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless AP 102 and any number of wireless STAs 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHz, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHz-24.25 GHZ), FR4a or FR4-1 (52.6 GHz-71 GHz), FR4 (52.6 GHz-114.25 GHZ), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHZ, 240 MHZ, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (such as the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6-bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or EDCA techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) and to enhance various aspects associated with wireless communication. For example, an AI/ML model may be trained to identify patterns or relationships in data observed in a wireless communication network 100. An AI/ML model may support operational decisions relating to aspects associated with wireless communications networks or services. For example, an AI/ML model may be utilized for supporting or improving aspects such as reducing signaling overhead (such as by CSI feedback compression), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and update the output based on a combination of the input data and the weights.

STAs or APs (such as a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QOS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as APs 102 and STAs 104) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (such as some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

In some wireless communication networks, such as the wireless communication network 100, various wireless communication devices (such as one or more APs 102 or one or more STAs 104, or any combination thereof) may support low-latency communication. Such low-latency communication may include data traffic associated with one or more low-latency (or otherwise latency-sensitive) applications. In some scenarios, such data traffic may be periodic or approximately periodic. In such scenarios, a wireless communication device may schedule, establish, or configure (and, for example, reserve or protect) one or more time regions via which the data may be transmitted or received. For example, a wireless communication device may schedule one or more target wake time (TWT) service periods (SPs), such as one or more restricted TWT (rTWT) SPs, via which the wireless communication device may expect to transmit or receive specific data. A set or schedule of one or more rTWT SPs may allow or prioritize communication associated with one or more select traffic types or communication to or from one or more select wireless communication devices and may be at least partially protected from other communication (such as in accordance with at least deprioritized channel access for other communication).

In some aspects, two or more APs 102 may coordinate with each other to provide additional protection for communication via one or more rTWT SPs. For example, a first AP 102 may schedule, establish, or configure a first set (such as a first schedule) of one or more rTWT SPs and the first AP 102 may inform a second AP 102 of the first set of one or more rTWT SPs. For example, the first AP 102 may announce the first set of one or more rTWT SPs via broadcast signaling, such as via one or more beacon frames or other management frames. Additionally, or alternatively, the first AP 102 and the second AP 102 may exchange (such as transmit or receive) one or more frames as part of a negotiation of the first set of one or more rTWT SPs. In accordance with informing the second AP 102 of the first set of one or more rTWT SPs or in accordance with negotiating the first set of one or more rTWT SPs with the second AP 102, the first AP 102 and the second AP 102 may achieve, realize, or otherwise facilitate a coordinated rTWT (C-rTWT). Generally, C-rTWT, such as a set or schedule of C-rTWT SPs, may be associated with (such as the result of) AP coordination for obtaining prioritized channel access at one or more coordinated times (such as at or within the C-rTWT SPs). The second AP 102 may terminate any ongoing TXOP prior to a C-rTWT SP of the first AP 102.

Additionally, or alternatively, two or more APs 102 may support and employ a coordinated listening instance (CLI), or multiple CLIs, via which the two or more APs 102 may exchange (such as transmit or receive) one or more frames. For example, a first AP 102 may coordinate or negotiate with a second AP 102 and schedule, configure, or establish time instances (such as CLIs) that provide “hooks” (such as triggers or opportunities) for additional frame exchanges (such as for further inter-AP coordination). The first AP 102 and the second AP 102 may use a CLI to exchange frames associated with C-TDMA, C-SR, or C-BF, among other examples. If the first AP 102 signals (such as indicates) a CLI, the second AP 102 may interrupt any ongoing TXOP so that transmissions to or from the second AP 102 avoid interfering with (such as crossing) the CLI. In some aspects, the first AP 102 may use a CLI to obtain channel access prioritization (such that one or more CLIs may be used to obtain or facilitate prioritized channel access for one or more APs 102 at one or more time instances).

In accordance with various aspects of the present disclosure, a “coordinated time region” may refer to any time epoch, instance, duration, opportunity, or window that is associated with one or more select wireless communication devices (such as a specific coordinating AP 102) and that is known by at least one other wireless communication device (such as at least one coordinated AP 102). In other words, a “coordinated time region” may be associated with any time epoch, instance, duration, opportunity, or window associated with a coordinated calendar/scheduling-based protocol, an SP-based subscription protocol (associated with, such as relying on, a control-based protocol or a distributed protocol), or a coordinated scheduling protocol. Additionally, a coordinated time region may be defined at least by a time instance (such as a beginning, an end, or another boundary of the region) and may sometimes be further delimited by an event (such as a transmission by an AP 102, such as a coordinating AP 102 or a coordinated AP 102) or a duration parameter.

For example, a C-rTWT SP may be an example of a coordinated time region defined via (such as in accordance with) a broadcast TWT element indicating a set of one or more SPs. For further example, a CLI may be an example of a coordinated time region and may provide (such as define) at least a start of the coordinated time region. Further, an AP 102 may signal or indicate one or more channel access parameters for another AP 102 to use to access a channel (such as a wireless medium) within a coordinated time region. For example, a first AP 102 may obtain an instruction (such as an indication) from a second AP 102 to use a specific set of one or more channel access (such as EDCA) parameters within a coordinated time region associated with the second AP 102.

In accordance with some example implementations, the first AP 102 may support and employ one or more signaling- or configuration-based mechanisms or protocols according to which the first AP 102 may provide prioritized channel access (such as prioritized EDCA) for the second AP 102 across various scenarios, including scenarios in which the first AP 102 has an ongoing channel access procedure at a beginning of the coordinated time region associated with the second AP 102. For example, the first AP 102 may interrupt the ongoing channel access procedure at or prior to the beginning of the coordinated time region and may attempt to obtain a TXOP in association with either resuming the interrupted (such as paused) channel access procedure or in association with initiating a new channel access procedure (if, for example, the interrupted channel access procedure is terminated or delayed).

As used herein, an “ongoing” channel access procedure at a beginning of a coordinated time region may be understood as any channel access procedure for which the first AP 102 has or will likely have a non-zero backoff counter value at the beginning of the coordinated time region, at approximately immediately before the beginning of the coordinated time region, within a threshold time duration of the beginning of the coordinated time region, or within a final slot before the beginning of the coordinated time region, among other examples. In some examples, the first AP 102 may project out an estimated (in accordance with historical channel congestion or channel access attempt statistics) end of a current channel access procedure to estimate, select, determine, or ascertain whether the current channel access procedure will or will likely be an ongoing channel access procedure at a beginning of a coordinated time region. In such examples, the first AP 102 may interrupt the channel access procedure in accordance with the projection (and, in some aspects, may not wait until a beginning boundary of the coordinated time region to interrupt the channel access procedure).

Likewise, as used herein, interrupting a channel access procedure “at or prior to a beginning” of a coordinated time region may refer to how the first AP 102 interrupts a channel access procedure at approximately a beginning boundary of the coordinated time region, which may include at (such as at a same time instance of), before, approximately immediately before, within a threshold time duration of, or within a final slot before the beginning of the coordinated time region. Further, as used herein, “interrupting” may refer to one or more of pausing, delaying, restricting, terminating, cancelling, suspending, or ceasing, among other examples. Further, “pausing” may generally relate to delaying or restricting, and “terminating” may generally relate to cancelling, suspending, or ceasing. For example, the first AP 102 may store a state associated with a paused channel access procedure and may discard a state associated with a terminated channel access procedure.

The first AP 102 and the second AP 102, among various other wireless communication devices described herein, may support one or more of capability signaling, configuration signaling, activation signaling, or deactivation signaling associated with the one or more mechanisms or protocols that the first AP 102 may employ to provide the prioritized channel access for the second AP 102. For example, the first AP 102 may indicate, to at least the second AP 102, a capability of the first AP 102 to support one or more mechanisms according to which the first AP 102 may select, identify, determine, or ascertain whether to pause or terminate an ongoing channel access procedure at a beginning of a coordinated time region, whether to save or discard a state associated with a paused or terminated channel access procedure, or whether to resume a paused channel access procedure at a later time or start a new channel access procedure. Additionally, or alternatively, the first AP 102 and the second AP 102 may exchange (such as transmit or receive) signaling associated configuring the first AP 102 with any one or more of such mechanisms (in accordance with the capability of the first AP 102). Additionally, or alternatively, the first AP 102 and the second AP 102 may exchange (such as transmit or receive) signaling associated with activating or deactivating any one or more of such mechanisms at the first AP 102 (in accordance with the capability of the first AP 102). The first AP 102 may statically employ a single mechanism, may dynamically, semi-persistently, or periodically switch between different mechanisms (such that different mechanisms may be used at different times), or may simultaneously employ different mechanisms for different coordinating APs 102, among other examples.

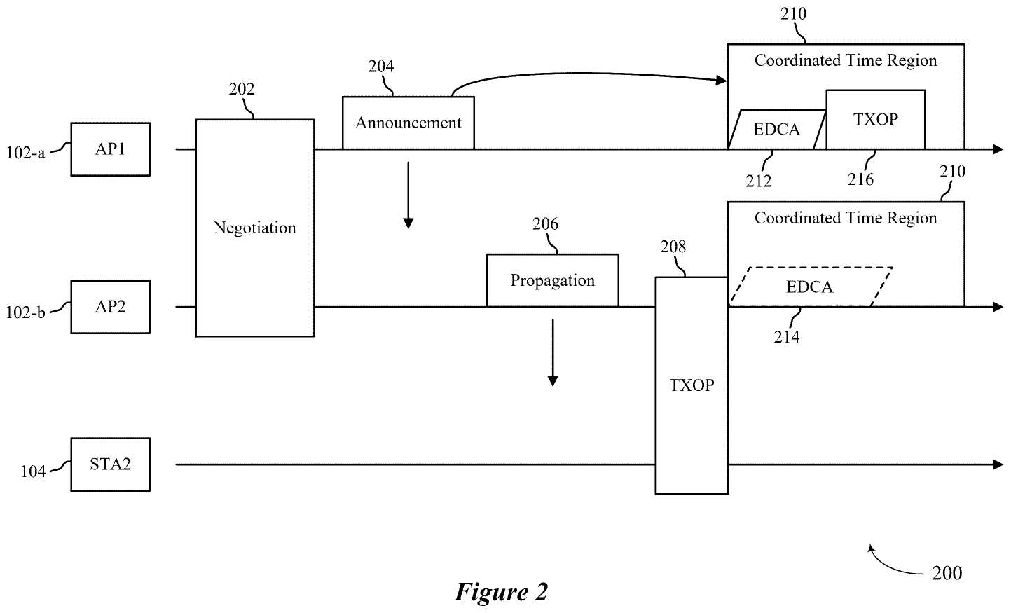

FIG. 2 shows an example communication timeline 200 that supports coordinated channel access between wireless APs. The communication timeline 200 may implement or be implemented to facilitate or realize aspects of the wireless communication network 100. For example, the communication timeline 200 illustrates communication between an AP 102-a, an AP 102-b, and a STA 104. The AP 102-a and the AP 102-b may each be an example of an AP 102 as illustrated by and described with reference to FIG. 1. The STA 104 may be an example of a STA 104 as illustrated by and described with reference to FIG. 1. In some implementations, the AP 102-a and the AP 102-b may support inter-AP coordination to protect or otherwise provide prioritized channel access during one or more time regions (such as during or within one or more coordinated time regions).

For example, the AP 102-a and the AP 102-b may employ inter-AP coordination to increase a capability of serving latency-sensitive traffic as, for example, the AP 102-b (a coordinated AP 102) may respect one or more protected time regions of the AP 102-a (a coordinating AP 102). In this way, a channel may be idle for a channel access attempt (such as via a channel access procedure) by the AP 102-a at a beginning of a protected time region (thus increasing a likelihood that the AP 102-a is able to efficiently obtain channel access). A protected time region, which may be an example of a coordinated time region, may refer to or include a C-rTWT SP, a CLI, or any time epoch or duration associated with a coordinated calendar/scheduling-based protocol, an SP-based subscription (associated with, such as relying on, a control-based protocol or a distributed protocol), or coordinated scheduling.

In some aspects, the AP 102-a and the AP 102-b may perform a negotiation 202. In accordance with the negotiation 202, the AP 102-a and the AP 102-b may exchange (such as transmit or receive) one or more frames including information indicative of one or more time regions (which may include one or both of time windows/durations or time epochs/instances). Such information indicative of one or more time regions may include one or more proposals for at least one time region, one or more acceptances (such as a confirmation) of at least one time region, one or more rejections of at least one time region, or one or more (proposed) modifications of at least one time region, among other examples.

In accordance with the negotiation 202, the AP 102-a may select, determine, identify, calculate, or ascertain one or more coordinated time regions that the AP 102-b will or will likely respect. The AP 102-a may perform an announcement 204 in association with selecting one or more coordinated time regions. For example, the AP 102-a may transmit (such as broadcast, such as via one or more beacon frames) information indicative of one or more coordinated time regions associated with the AP 102-a. A coordinated time region that is associated with the AP 102-a may be understood as a coordinated time region that is “owned” by the AP 102-a or a coordinated time region within which the AP 102-a has prioritized access.

In some examples, the AP 102-a may indicate a coordinated time region 210 via the announcement 204. Additionally, in some examples, the AP 102-a may indicate a set of channel access parameters associated with the coordinated time region 210 via the announcement 204. For example, to provide, configure, or otherwise facilitate a prioritized channel access for the AP 102-a within the coordinated time region 210, the AP 102-a may transmit an indication of a set of channel access parameters (such as a set of EDCA parameters) for the AP 102-b (among potentially other APs 102 or STAs 104) to use within the coordinated time region 210. Such indicated channel access parameters for the AP 102-b to use within the coordinated time region 210 may provide, configure, or otherwise facilitate a deprioritized channel access for the AP 102-b within the coordinated time region 210. For example, the set of channel access parameters may indicate (for a given AC or across multiple ACs) relatively larger upper limit or lower limit CW sizes, a relatively larger AIFS number (AIFSN), or both as compared to a CW size or an AIFSN that the AP 102-b may otherwise use outside of the coordinated time region 210.

In some implementations, the AP 102-a may indicate a respective set of channel access parameters associated with the coordinated time region 210 for each AC at the AP 102-a or the AP 102-b. For example, the AP 102-a may indicate a first set of channel access parameters that corresponds to a first AC within the coordinated time region 210 and a second set of channel access parameters that corresponds to a second AC within the coordinated time region 210. In such examples, the AP 102-a may indicate a first AIFSN [AC₁] value associated with the first AC and may indicate a second AIFSN [AC₂] value associated with the second AC. In some other implementations, the AP 102-a may indicate a single set of channel access parameters associated with the coordinated time region 210 that applies to, for example, multiple ACs at the AP 102-a or the AP 102-b. For example, the AP 102-a may indicate a single set of channel access parameters that corresponds to both a first AC and a second AC within the coordinated time region 210.

The AP 102-b, in association with receiving the announcement 204 from the AP 102-a, may store information associated with (such as indicative of) the coordinated time region 210. For example, the AP 102-b may store information associated with a location (such as a time domain location) of the coordinated time region 210, a periodicity of the coordinated time region 210 (in examples in which the coordinated time region 210 is periodic), or a duration of the coordinated time region 210 (in examples in which the AP 102-a signals the duration of the coordinated time region 210), among other examples. Additionally, in some examples, the AP 102-b may store information associated with (such as indicative of) the set of channel access parameters that is associated with the coordinated time region 210.

In some examples, the AP 102-b may perform a propagation 206 of the information associated with the coordinated time region 210. For example, the AP 102-b may transmit (such as broadcast, such as via one or more beacon frames or other management frames) information indicative of the coordinated time region 210 and, in some implementations, indicative of the set of channel access parameters associated with the coordinated time region 210. In accordance with the propagation 206, the AP 102-b may reinforce the protection of the coordinated time region 210 as additional wireless communication devices (such as one or more STAs 104 associated with the AP 102-b) may receive information indicative of the coordinated time region 210 (and thus respect or honor the coordinated time region 210). For example, the AP 102-b may schedule, configure, or establish an rTWT (such as an EHT rTWT) or another coordinated time region with one or more client devices of the AP 102-b (such as the STA 104) so that the coordinated time region 210 of the AP 102-a is protected. In other words, the AP 102-b may advertise, in one or more beacon frames of the AP 102-b, an OBSS rTWT schedule so that STAs associated with the AP 102-b supporting rTWT follow a set of rTWT rules associated with the OBSS rTWT schedule.

The AP 102-b may honor or respect the coordinated time region 210 associated with the AP 102-a. For example, if the AP 102-b has an ongoing TXOP 208 at a beginning of the coordinated time region 210, the AP 102-b may terminate the TXOP 208 at or prior to the beginning of the coordinated time region 210. In other words, the AP 102-b may terminate the TXOP 208 such that transmissions within the TXOP 208 do not exceed the beginning (such as the boundary) of the coordinated time region 210 (such that the TXOP 208 ends before a start time of the corresponding OBSS rTWT SP(s)). In some aspects, the AP 102-b may interrupt the TXOP 208 before (such as at or prior to a beginning of) the coordinated time region 210 so that the channel is free (such as idle or available) for a channel access attempt by the AP 102-a.

The AP 102-a may initiate (such as start, invoke, or begin) a channel access procedure 212 at or after (such as immediately after, approximately immediately after, or within a threshold time duration after) the beginning of the coordinated time region 210 in an attempt to obtain a TXOP 216 within the coordinated time region 210. In accordance with terminating the TXOP 208, the AP 102-b may, in some implementations, perform a channel access procedure 214 at or after (such as immediately after, approximately immediately after, or within a threshold time duration after) the beginning of the coordinated time region 210 in an attempt to obtain another TXOP. The AP 102-b may perform the channel access procedure 214 in accordance with the indicated set of channel access parameters associated with the coordinated time region 210.

In some implementations, the AP 102-b may support one or more mechanisms (such as one or more protocols) according to which the AP 102-b may provide prioritized channel access (such as prioritized EDCA) for the AP 102-a (or any AP 102 announcing one or more coordinated times) across various scenarios, including scenarios in which the AP 102-b has or will likely have an ongoing channel access procedure at the beginning of the coordinated time region 210. In accordance such one or more mechanisms, the AP 102-b may interrupt (such as pause or terminate) an ongoing channel access procedure (such as an ongoing EDCA attempt) at or prior to the beginning of the coordinated time region 210 and may either resume the interrupted channel access procedure at a later time or initiate a new channel access procedure at a later time. Such a later time may be within the coordinated time region 210 or after the coordinated time region 210 in accordance with the various mechanisms disclosed herein. Further, the AP 102-b may resume the previous channel access procedure or initiate the new channel access procedure in accordance with one or both of a default (such as baseline) set of channel access parameters or the indicated set of channel access parameters associated with the coordinated time region 210. Such a default or baseline set of channel access parameters may be a set of channel access parameters that the AP 102-b uses outside of coordinated time regions.

Further, in some implementations, the AP 102-b may support one or more mechanisms according to which the AP 102-b may provide prioritized channel access for the AP 102-a in scenarios in which the AP 102-b has an ongoing TXOP 208 at a beginning of the coordinated time region 210. In some implementations, the AP 102-b may interrupt the TXOP 208 and initiate a channel access procedure 214 in accordance with the channel access parameters associated with the coordinated time region 210 (as indicated by the AP 102-a). In such implementations, the AP 102-b may initiate the channel access procedure 214 in accordance with a rule that indicates that the AP 102-b (or, generally, any coordinated AP 102) is expected to start a new channel access procedure (for a given, expected, or specific AC) within the coordinated time region 210 associated with the AP 102-a. Additionally, or alternatively, the AP 102-b may initiate the channel access procedure 214 in accordance with a rule that indicates that the AP 102-b (or, generally, any coordinated AP 102) is expected to classify (such as consider) a beginning of the coordinated time region 210 as a channel busy event (regardless of a current energy on the channel). In some other implementations, the AP 102-b may interrupt the TXOP 208 and may refrain from initiating (such as determine not to initiate) a channel access procedure 214 within the coordinated time region 210. In such implementations, the AP 102-b may refrain from initiating the channel access procedure 214 within the coordinated time region 210 in accordance with a rule that indicates that the AP 102-b (or, generally, any coordinated AP 102) is prohibited (such as not allowed) from contending for channel access during the coordinated time region 210 (or any coordinated time region).

Further, in some implementations, the AP 102-b may support one or more mechanisms according to which the AP 102-b may provide prioritized channel access for the AP 102-a in scenarios in which a traffic arrival occurs at the AP 102-b within the coordinated time region 210. In some implementations, the AP 102-b may initiate a channel access procedure 214 within the coordinated time region 210 in accordance with (such as responsive to or based on) the traffic arrival. In such implementations, the AP 102-b may initiate the channel access procedure 214 in accordance with the channel access parameters associated with the coordinated time region 210 (as indicated by the AP 102-a). In other words, channel access within the coordinated time region 210 may follow the channel access parameters announced by the AP 102-a (which may be negotiated or provided, such as specified). In some other implementations, the AP 102-b may refrain from initiating a channel access procedure 214 within the coordinated time region 210 in accordance with (such as responsive to or based on) the traffic arrival. In such implementations, the AP 102-b may refrain from initiating the channel access procedure 214 within the coordinated time region 210 in accordance with a rule that indicates that the AP 102-b (or, generally, any coordinated AP 102) is prohibited (such as not allowed) from contending for channel access during the coordinated time region 210 (or any coordinated time region). Instead, the AP 102-b may initiate a channel access procedure after the coordinated time region 210 in an attempt to obtain a TXOP for the traffic that arrived during the coordinated time region 210.

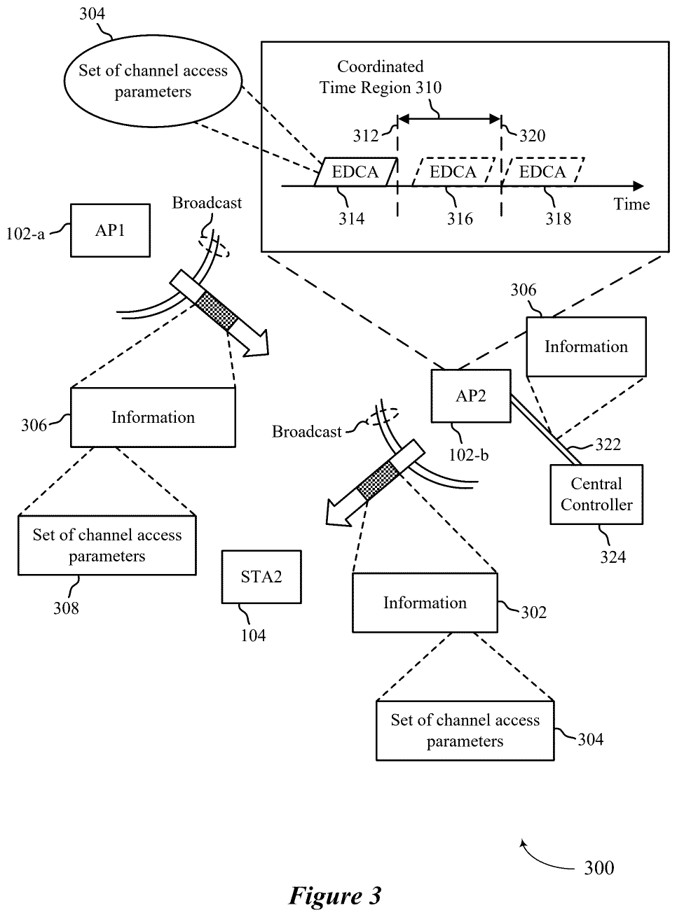

FIG. 3 shows an example signaling diagram 300 that supports coordinated channel access between wireless APs. The signaling diagram 300 may implement or be implemented to realize one or more aspects of the wireless communication network 100 or the communication timeline 200. For example, the signaling diagram 300 illustrates communication between an AP 102-a, an AP 102-b, and a STA 104. The AP 102-a and the AP 102-b as illustrated by FIG. 3 may be examples of the AP 102-a and the AP 102-b, respectively, as illustrated by and described with reference to FIG. 2. The STA 104 as illustrated by FIG. 3 may be an example of the STA 104 as illustrated by and described with reference to FIG. 2.

The AP 102-b may transmit (such as broadcast, such as via a first set of one or more management frames, such as via a first set of individually addressed management frames or a first set of beacon frames) information 302 indicative of a set of channel access parameters 304. The set of channel access parameters 304 may be default or baseline channel access parameters that the AP 102-b uses outside of coordinated time regions (such as outside of coordinated time regions associated with a different or specified set of channel access parameters). The AP 102-b may convey or provide the information 302 via one or more elements, fields, or subfields of one or more frames (such as of the first set of one or more management frames).

The AP 102-a may transmit (such as broadcast, such as via a second set of one or more management frames, such as via a second set of individually addressed management frames or a second set of beacon frames) information 306 indicative of a set of channel access parameters 308 associated with a coordinated time region 310. The AP 102-a may convey or provide the information 306 via one or more elements, fields, or subfields of a frame (such as of the second set of one or more management frames). Accordingly, the AP 102-b may parse, identify, determine, ascertain, or derive the information 306 from one or more frames transmitted by the AP 102-a (such as individually addressed management frames or beacon frames). In some implementations, the AP 102-a may transmit the information 306 via an announcement (such as a schedule announcement), such as the announcement 204 as illustrated by and described with reference to FIG. 2. In some aspects, the AP 102-b may propagate the information 306 via one or more frames transmitted by the AP 102-b (such as via the first set of management frames or one or more other frames).

Additionally, or alternatively, the AP 102-b may receive (such as obtain or derive) the information 306 via a (wired or wireless) backhaul link 322. For example, the AP 102-b may receive the information 306 from a central controller 324 via the backhaul link 322. In such examples, the AP 102-b may parse, identify, determine, ascertain, or derive the information 306 from one or more frames including a configuration (such as from the central controller 324 providing a configuration via the backhaul link 322). In other words, in some implementations, the AP 102-b may receive (such as obtain, parse, derive, or otherwise determine) the information 306 from an external source other than the AP 102-a (such as outside the AP-AP communication between the AP 102-a and the AP 102-b). The central controller 324 may provide the information 306 to the AP 102-b via wired or wireless signaling. In some aspects, the central controller 324 (or any other network node or entity) may provide the information 306 to the AP 102-b by way of a configuration via one or more management frames.

In some implementations, the information 306 also may include an indication of the coordinated time region 310. For example, the information 306 may indicate one or more of a start time of the coordinated time region 310, an end time of the coordinated time region 310, a duration of the coordinated time region 310, or a periodicity of the coordinated time region 310. The coordinated time region 310 may be an example of the coordinated time region 210 as illustrated by and described with reference to FIG. 2.

In some implementations, the AP 102-b may support one or more mechanisms according to which the AP 102-b may provide prioritized channel access (such as prioritized EDCA) for the AP 102-a across various scenarios, including scenarios in which the AP 102-b has an ongoing channel access procedure at a beginning 312 of the coordinated time region 310 associated with the AP 102-a. For example, the AP 102-b may initiate a channel access procedure 314 prior to the coordinated time region 310 and the channel access procedure 314 may be ongoing (such that a backoff counter value associated with the channel access procedure 314 has yet to reach zero or will likely not reach zero) at the beginning 312 of the coordinated time region 310. In accordance with initiating the channel access procedure 314 prior to the coordinated time region 310, the AP 102-b may initiate the channel access procedure 314 in accordance with the set of channel access parameters 304 (such as the default or baseline parameters used by the AP 102-b). In accordance with the one or more mechanisms, the AP 102-b may interrupt (such as pause or terminate) the channel access procedure 314 at or prior to the beginning 312 of the coordinated time region 310.

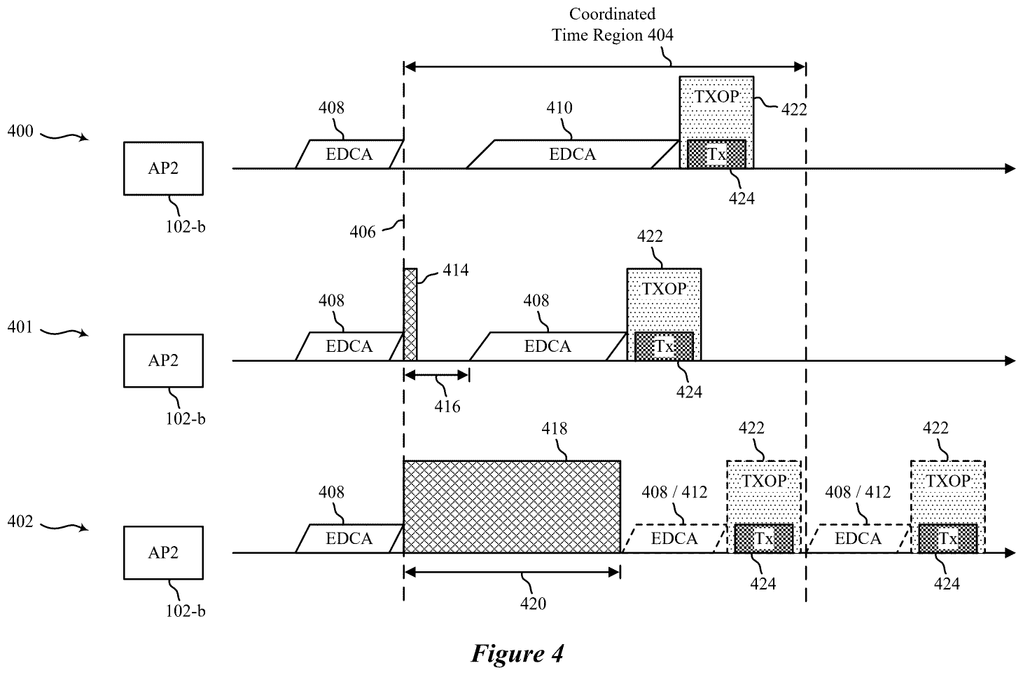

In association with interrupting the channel access procedure 314 at or prior to the beginning 312 of the coordinated time region 310, the AP 102-b may resume the channel access procedure 314 at a later time (if the channel access procedure 314 is paused and stored) or may initiate a new channel access procedure at a later time (if the channel access procedure 314 is terminated and discarded). In some implementations, for example, the AP 102-b may terminate the channel access procedure 314 at or prior to the beginning 312 of the coordinated time region 310 and start a (new) channel access procedure 316 within the coordinated time region 310. Additionally, or alternatively, the AP 102-b may pause the channel access procedure 314 at or prior to the beginning 312 of the coordinated time region 310 and resume the channel access procedure 314 within the coordinated time region 310. Additionally, or alternatively, the AP 102-b may pause or terminate the channel access procedure 314 at or prior to the beginning 312 of the coordinated time region 310 and may either resume the paused channel access procedure 314 or start a (new) channel access procedure 318 outside of the coordinated time region 310. Additional details relating to such various implementations are illustrated and described herein, including by and with reference to FIG. 4.

In some implementations, the AP 102-b may support one or more mechanisms according to which the AP 102-b may select, determine, identify, or ascertain one or more limits or conditions within which to use the set of channel access parameters 308. For example, the AP 102-b may activate and use the set of channel access parameters 308 starting at or after the beginning 312 of the coordinated time region 310 and may deactivate and refrain from using the set of channel access parameters 308 starting at an end 320 of the coordinated time region 310. In other words, the AP 102-b may stop using the set of channel access parameters 308 announced by the AP 102-a in accordance with reaching the end 320 of the coordinated time region 310. The AP 102-b may select, determine, identify, or ascertain the end 320 of the coordinated time region 310 in accordance with a satisfaction of the one or more limits or conditions.

In some implementations, the AP 102-b may select, determine, identify, or ascertain the end 320 of the coordinated time region 310 in accordance with the AP 102-b obtaining a threshold quantity (such as K1) of channel accesses to the medium. K1 may be any quantity greater than or equal to 1. The AP 102-b may receive an indication of K1 from the AP 102-a (such as via the information 306 or in accordance with the negotiation 202), may retrieve an indication of K1 from one or more memories located at the AP 102-b or from one or more memories (such as a cloud-based storage) located separately from the AP 102-b (such as in accordance with a network specification), or may receive or derive an indication of K1 from a configuration (such as a configuration provided by, for example, the information 306 from the central controller 324). Additionally, or alternatively, the AP 102-b may select, determine, identify, or ascertain the end 320 of the coordinated time region 310 in accordance with the AP 102-a obtaining a threshold quantity (such as K2) of channel access to the medium. K2 may be any quantity greater than or equal to 1. The AP 102-b may receive an indication of K2 from the AP 102-a (such as via the information 306 or in accordance with the negotiation 202), may retrieve an indication of K2 from one or more memories located at the AP 102-b or from one or more memories (such as a cloud-based storage) located separately from the AP 102-b (such as in accordance with a network specification), or may receive or derive an indication of K2 from a configuration (such as a configuration provided by, for example, the information 306 from the central controller 324). The AP 102-b may detect a channel access by the AP 102-a by monitoring the channel and parsing at least a portion of one or more frame transmissions (such as a preamble portion or another portion of the one or more frame transmissions that includes information indicative of a transmitter).

Additionally, or alternatively, the AP 102-b may select, determine, identify, or ascertain the end 320 of the coordinated time region 310 in accordance with a duration signaled or provided by the AP 102-a or the central controller 324 (or any other network node or entity), such as via the information 306. For example, the information 306 (which may be signaled by the AP 102-a or provided by the central controller 324) may include an indication of a start time (such as a time instance corresponding to the beginning 312 of the coordinated time region 310) and an indication of a duration and the AP 102-b may calculate a time instance that corresponds to the end 320 of the coordinated time region 310 in association with adding the duration to the start time. For example, the coordinated time region 310 may be a C-rTWT SP and the end 320 of the coordinated time region 310 may be the end of the C-rTWT SP. Additionally, or alternatively, the information 306 may include an explicit indication of an end time of the coordinated time region 310, such as via one or more elements, fields, or subfields.

Additionally, or alternatively, the AP 102-b may select, determine, identify, or ascertain the end 320 of the coordinated time region 310 in accordance with encountering (such as experiencing, measuring, or determining) a threshold quantity (such as K3) of channel busy events, such as a threshold quantity of channel busy events within a channel access procedure 316 performed by the AP 102-b within the coordinated time region 310. K3 may be any quantity greater than or equal to 1. The AP 102-b may receive an indication of K3 from the AP 102-a (such as via the information 306 or in accordance with the negotiation 202), may retrieve an indication of K3 from one or more memories located at the AP 102-b or from one or more memories (such as a cloud-based storage) located separately from the AP 102-b (such as in accordance with a network specification), or may receive or derive an indication of K3 from a configuration (such as a configuration provided by, for example, the information 306 from the central controller 324).

Additionally, or alternatively, the AP 102-b may select, determine, identify, or ascertain the end 320 of the coordinated time region 310 in accordance with entering a second coordinated time region (such as a coordinated time region different from the coordinated time region 310). The second coordinated time region may be associated with a second AP 102 (such as another coordinating AP 102 different than the AP 102-a). In some scenarios, the coordinated time region 310 and the second coordinated time region may be non-overlapping (such that, for example, the coordinated time region 310 ends at the same time or at approximately the same time that the second coordinated time region begins or at a time before the second coordinated time region begins). In some other scenarios, the coordinated time region 310 and the second coordinated time region may be at least partially overlapping in the time domain. In such scenarios, the AP 102-b may select, determine, identify, or ascertain whether to use the set of channel access parameters 308 associated with the coordinated time region 310 or a set of channel access parameters associated with the second coordinated time region in accordance with one or more conditions.

For example, the AP 102-b may use a relatively more strict or restrictive set of channel access parameters between the set of channel access parameters 308 associated with the coordinated time region 310 and the set of channel access parameters associated with the second coordinated time region. Additionally, or alternatively, the AP 102-b may select which channel access parameters to use in accordance with a signal strength, such as a received signal strength indicator (RSSI), measurement. For example, if the AP 102-b receives a frame (such as a beacon frame) carrying the information 306 indicative of the coordinated time region 310 with a smaller signal strength as compared to a frame (such as a beacon frame) carrying information indicative of the second coordinated time region, the AP 102-b may select to use the set of channel access parameters associated with the second coordinated time region. Additionally, or alternatively, the AP 102-b may use channel access parameters indicated by a relatively friendlier of the AP 102-a and the second AP 102. For example, if the second AP 102 has (within, for example, a specific time duration) violated one or more coordinated time regions of the AP 102-b relatively fewer times as compared to the AP 102-a, the AP 102-b may select to use the set of channel access parameters associated with the second coordinated time region. Additionally, or alternatively, the AP 102-a and the second AP 102 may each signal a respective priority associated with their respective coordinated time regions and the AP 102-b may select to use the channel access parameters associated with the coordinated time region that is associated with the relatively higher priority.

Further, although some aspects are illustrated and described in the context of channel access procedures at the AP 102-b, various wireless communication devices may implement the disclosed aspects to provide prioritized channel access to the AP 102-a. For example, the STA 104 (which may be associated with the AP 102-b) may receive (such as obtain or derive) the information 306 indicative of the set of channel access parameters 308 associated with the coordinated time region 310 and may perform or interrupt one or more channel access procedures in accordance with the coordinated time region being associated with the set of channel access parameters 308. In other words, the STA 104 may follow (such as use) the set of channel access parameters 308, as advertised by the AP 102-a (a neighboring or OBSS AP 102), in accordance with one or more of the various mechanisms and protocols disclosed herein. The STA 104 may receive the information 306 indicative of the set of channel access parameters 308 via one or more broadcast frames (such as beacon frames) transmitted by the AP 102-a or via one or more broadcast frames (such as beacon frames) transmitted by the AP 102-b (in accordance with the AP 102-b advertising or propagating the information 306). In examples in which the STA 104 receives the information 306 from the AP 102-b via one or more broadcast frames, the AP 102-b may indicate the information 302 via a first element of a frame (which the STA 104 may interpret as indicating in-BSS channel access parameters) and may indicate the information 306 via a second element of the frame (which the STA 104 may interpret as indicating OBSS channel access parameters). In such examples, the STA 104 may apply the set of channel access parameters 308 within the coordinated time region 310 associated with the AP 102-a. Additionally, or alternatively, the STA 104 may interrupt (such as pause or terminate) an ongoing channel access procedure at or prior to the beginning of the coordinated time region 310 in accordance with being aware of the set of channel access parameters 308 associated the coordinated time region 310.

FIG. 4 shows example communication timelines 400, 401, and 402 that support coordinated channel access between wireless APs. The communication timelines 400, 401, and 402 may implement or be implemented to realize one or more aspects of the wireless communication network 100, the communication timeline 200, or the signaling diagram 300. For example, the communication timelines 400, 401, and 402 illustrate example channel access mechanisms that an AP 102-b may implement within a coordinated time region 404 associated with another AP 102 (such as an AP 102-a as illustrated by and described with reference to FIGS. 2 and 3).

The AP 102-b of FIG. 4 may be an example of the AP 102-b as illustrated by and described with reference to FIGS. 2 and 3. The coordinated time region 404 may be an example of the coordinated time region 210 and the coordinated time region 310 as illustrated by and described with reference to FIGS. 2 and 3, respectively. The AP 102-b may support one or more mechanisms associated with defining a protocol for channel access by the AP 102-b within the coordinated time region 404 of the AP 102-a, including in scenarios in which the AP 102-b has an ongoing first channel access procedure 408 (such as an ongoing EDCA attempt) at a boundary of the coordinated time region 404 (such as at a beginning 406 of the coordinated time region 404). In some aspects, the AP 102-b may initiate the first channel access procedure 408 in accordance with a default or baseline set of channel access parameters, such as the set of channel access parameters 304 as illustrated by and described with reference to FIG. 3. Further, although some example channel access protocols are described in an example context of being performed by or at the AP 102-b, a STA 104 (such as a STA 104 associated with the AP 102-b) may equivalently implement one or more of the various channel access protocols disclosed herein.

In some implementations, and as illustrated by the communication timeline 400, the AP 102-b may start a new channel access procedure (such as a new EDCA attempt) for a given, expected, or scheduled AC within the coordinated time region 404. For example, if the AP 102-b is already performing the first channel access procedure 408 prior to the beginning 406 of the coordinated time region 404, the AP 102-b may interrupt the first channel access procedure 408 at or prior to the beginning 406 of the coordinated time region 404 and may initiate a second channel access procedure 410 (a new EDCA attempt) within the coordinated time region 404. In some examples, the AP 102-b may initiate the second channel access procedure 410 in accordance with a set of channel access parameters associated with the coordinated time region 404, such as the set of channel access parameters 308 as illustrated by and described with reference to FIG. 3. The AP 102-b may initiate the second channel access procedure 410 approximately immediately at or after the beginning 406 of the coordinated time region 404, after or within a threshold time duration (a time delay, such as approximately 1 microsecond) after the beginning 406 of the coordinated time region 404, or after or within a first (initial in time) slot after the beginning 406 of the coordinated time region 404, among other examples.

In some examples, the AP 102-b may store a state (such as a state of a backoff counter value) of the first channel access procedure 408 at or prior to the beginning 406 of the coordinated time region 404 in association with interrupting the first channel access procedure 408 at or prior to the beginning 406 of the coordinated time region 404. In such examples, the AP 102-b may resume the first channel access procedure 408 outside of the coordinated time region 404 (such as after the coordinated time region 404). For example, if a backoff counter value associated with the first channel access procedure 408 is a first value at interruption (which may be at or prior to the beginning 406 of the coordinated time region 404), the AP 102-b may resume the first channel access procedure 408 after the coordinated time region 404 by way of starting with a backoff counter value set equal to the first value (as opposed to, for example, selecting a new backoff counter value upon exit from the coordinated time region 404). Such a backoff counter value may be referred to herein as an EDCA backoff (EB).

In some other examples, the AP 102-b may discard (such as drop) the first channel access procedure 408 and start a new channel access procedure after the coordinated time region 404. For example, the AP 102-b may cancel the first channel access procedure 408 (a previous EDCA attempt) and may start a new channel access procedure (as the previous state is discarded and lost) in accordance with the set of channel access parameters 304 after the coordinated time region 404.

In some implementations, the AP 102-b may keep track of (such as maintain and store) an EB state separately for in-coordinated-region and out-of-coordinated-region (as opposed to, for example, initializing a backoff counter in accordance with a single EB state tracking any channel access attempt regardless of the time region). For example, the AP 102-b may maintain (such as initialize, update, or reinitialize) a first backoff counter value for use outside of coordinated time regions and may maintain (such as initialize, update, or reinitialize) a second backoff counter value for use within coordinated time regions (including, for example, within the coordinated time region 404).

In some implementations, and as illustrated by the communication timeline 401, the AP 102-b may classify the beginning 406 of the coordinated time region 404 as a channel busy event 414. In some examples, the AP 102-b may classify the beginning 406 of the coordinated time region 404 as a channel busy event 414 regardless of a current or actual energy associated with the channel. For example, a rule associated with the coordinated time region 404 may indicate, specify, or define that the AP 102-b is expected to classify the beginning 406 of the coordinated time region 404 as a channel busy event 414 independent of one or more energy detection measurements performed by the AP 102-b at or near the beginning 406 of the coordinated time region 404. Thus, the channel busy event 414 may be referred to or understood as a virtual channel busy event. In some aspects, the channel busy event 414 may be an instantaneous channel busy event (such that the channel busy event 414 may not be associated with a duration, or may be associated with a duration of zero). In some other aspects, the channel busy event 414 may have a duration (such as a non-zero duration). The AP 102-b may receive (such as obtain or derive) an indication of the duration via the information 306 or via one or more frames associated with the negotiation 202 between the AP 102-a and the AP 102-b.

In such examples, if the first channel access procedure 408 is or will likely be ongoing at the beginning 406 of the coordinated time region 404, the AP 102-b may pause the first channel access procedure 408 and may resume a backoff counter value countdown associated with the first channel access procedure 408 (within the coordinated time region 404) in accordance with (such as after) detecting the channel to be idle for a threshold time duration 416 after the channel busy event 414 (such as after the beginning 406 of the coordinated time region 404 in examples in which the channel busy event 414 is an instantaneous channel busy event). Such a threshold time duration 416 may be associated with an xIFS duration, which may refer generally to one or more of an SIFS, a DIFS, an EIFS, or an AIFS. Additionally, or alternatively, the threshold time duration 416 may be associated with a quantity of one or more slots. Additionally, or alternatively, the threshold time duration 416 may be associated with (such as may be or may be indicated by) an SP (such that an end or expiration of the threshold time duration 416 may correspond to an end time of the SP). Such an SP may be owned by or otherwise associated with the AP 102-a. The threshold time duration 416 may span a portion of the coordinated time region 404, an entirety (such as a full duration) of the coordinated time region 404, or a duration longer than the coordinated time region 404.

In some examples, the AP 102-b may detect an idle channel for a threshold time duration 416 calculated (such as computed or otherwise determined) in accordance with Equation 1, shown below, before resuming the countdown associated with the first channel access procedure 408 within the coordinated time region 404.

$${AIFS}^{′} [ A C ] = SIFS + {AIFSN}^{′} [ A C ] \times 9 µs ) . \qquad ( 1 )$$

In the example of Equation 1, AIFS′ and AIFSN′ may denote values that are specific to (such as associated with) the coordinated time region 404. Further, AIFSN′ may denote an AIFSN value indicated by the set of channel access parameters 308. Thus, in accordance with Equation 1, the AP 102-b may calculate the threshold time duration 416 in accordance with one or more parameters associated with the set of channel access parameters 308. Additionally, or alternatively, the threshold time duration 416 may be (directly or explicitly) indicated by a parameter of the set of channel access parameters 308. Additionally, or alternatively, the threshold time duration 416 may be an object or parameter of the negotiation 202 between the AP 102-a and the AP 102-b. In some aspects, the AP 102-a or the central controller 324 may signal or configure a value of the threshold time duration 416 to dynamically, semi-persistently, periodically, or statically adjust how protected the coordinated time region 404 (such that, for example, a relatively longer threshold time duration 416 may provide relatively greater protection).

In association with resuming the first channel access procedure 408 within the coordinated time region 404, the AP 102-b may effectively resume the first channel access procedure 408 in accordance with a hybrid set of channel access parameters that includes one or more parameters associated with the set of channel access parameters 304 and one or more parameters associated with the set of channel access parameters 308. For example, the AP 102-b may calculate the threshold time duration 416 in accordance with an AIFSN value indicated by the set of channel access parameters 308 (or may obtain an indication of the threshold time duration 416) and may resume a backoff counter value selected in accordance with the set of channel access parameters 304 (such as in accordance with a CW size within a range of CW sizes indicated by the set of channel access parameters 304). In such examples, the threshold time duration 416 may be associated with the set of channel access parameters 308 and the backoff counter value may be associated with the set of channel access parameters 304.

In some implementations, and as illustrated by the communication timeline 402, the AP 102-b may classify at least a portion of the coordinated time region 404 as a channel busy event 418. In some examples, the AP 102-b may classify the portion or an entirety of the coordinated time region 404 as a channel busy event 418 regardless of a current or actual energy associated with the channel. For example, a rule associated with the coordinated time region 404 may indicate, specify, or define that the AP 102-b is expected to classify the portion or the entirety of the coordinated time region 404 as a channel busy event 418 independent of one or more energy detection measurements performed by the AP 102-b within the portion or the entirety of the coordinated time region 404. Additionally, or alternatively, the rule may indicate, specify, or define that the AP 102-b is prohibited from contending for channel access within the portion or the entirety of the coordinated time region 404. A channel busy event 418, which may be understood as a virtual channel busy event, may indicate to the AP 102-b, or to one or more entities or layers associated with the AP 102-b, that the channel or medium is occupied by one or more other wireless communication devices.

In some examples, the AP 102-b may pause the first channel access procedure 408 at or prior to the beginning 406 of the coordinated time region 404 in association with classifying the portion or the entirety of the coordinated time region 404 as the channel busy event 418. In other words, the AP 102-b may freeze and store a backoff counter value associated with the first channel access procedure 408 at or prior to the beginning 406 of the coordinated time region 404 and may resume the first channel access procedure 408 (at the previously frozen and stored backoff counter value) after the portion or the entirety of the coordinated time region 404. In some other examples, the AP 102-b may terminate the first channel access procedure 408 at or prior to the beginning 406 of the coordinated time region 404 in association with classifying the portion or the entirety of the coordinated time region 404 as the channel busy event 418. In such examples, the AP 102-b may discard a state associated with the first channel access procedure 408 and, because the previous state is lost if discarded, the AP 102-b may initiate a second channel access procedure 412 outside of (such as after) the portion or the entirety of the coordinated time region 404. The AP 102-b may initiate the second channel access procedure 412 in accordance with the set of channel access parameters 304 in association with initiating the second channel access procedure 412 outside of the coordinated time region 404. Alternatively, the AP 102-b may initiate the second channel access procedure 412 in accordance with the set of channel access parameters 308 in association with initiating the second channel access procedure 412 within the coordinated time region 404.

In some implementations, the AP 102-b may determine whether to pause the first channel access procedure 408 or to terminate the first channel access procedure 408 in accordance with a duration of the coordinated time region 404 or in accordance with a duration 420 of the channel busy event 418. For example, if the coordinated time region 404 (or the duration 420 of the channel busy event 418) is less than or equal to a threshold time duration, the AP 102-b may pause the first channel access procedure 408 (for later resumption after the coordinated time region 404 or after the channel busy event 418, which may be within the coordinated time region 404 or after the coordinated time region 404). Alternatively, if the coordinated time region 404 (or the duration 420 of the channel busy event 418) is greater than the threshold time duration, the AP 102-b may terminate the first channel access procedure 408 (and instead initiate the second channel access procedure 412 after the coordinated time region 404 or after the channel busy event 418, which may be within the coordinated time region 404 or after the coordinated time region 404).

In some examples, the AP 102-b may resume the first channel access procedure 408 or initiate the second channel access procedure 412 (approximately) immediately after the coordinated time region 404 or after detecting an idle channel for a threshold time duration (such as the threshold time duration 416) after the coordinated time region 404. In some other examples, the AP 102-b may resume the first channel access procedure 408 or initiate the second channel access procedure 412 (approximately) immediately after the channel busy event 418 or after detecting an idle channel for a threshold time duration (such as the threshold time duration 416) after the channel busy event 418.

In some implementations, the AP 102-b may obtain an indication of the duration 420 of the channel busy event 418 (such as a duration of the portion of the coordinated time region 404 that the AP 102-b classifies as the channel busy event 418). For example, the AP 102-b may obtain an indication of the duration 420 via the information 306 (such as from the AP 102-a or a configuration from, for example, the central controller 324) or via one or more frames associated with the negotiation 202 between the AP 102-a and the AP 102-b. For example, the AP 102-b may obtain the indication of the duration 420 via a Duration parameter. Such a Duration parameter may be included within a subset of the information 306 that indicates information associated with the coordinated time region 404 (such that coordinated time region information indicates the duration 420 of the channel busy event 418) or within a subset of the information 306 that indicates information associated with the set of channel access parameters 308 (such that channel access parameter information indicates the duration 420 of the channel busy event 418). Additionally, or alternatively, the duration 420 of the channel busy event 418 may be an object or parameter of the negotiation 202 between the AP 102-a and the AP 102-b.

In association with performing the first channel access procedure 408, the second channel access procedure 410, or the second channel access procedure 412, the AP 102-b may obtain a TXOP 422. In other words, the AP 102-b may, in some scenarios, obtain or win access to the channel for a TXOP 422 in accordance with performing the first channel access procedure 408, the second channel access procedure 410, or the second channel access procedure 412. The AP 102-b may participate in wireless communication with (such as a transmission, or “Tx,” to) one or more other wireless communication devices within the TXOP 422. Such one or more other wireless communication devices may include one or more APs 102 (such as the AP 102-a) or one or more STAs 104 (such as one or more STAs 104 associated with the AP 102-b). In some examples, the AP 102-b may transmit a frame 424 within the TXOP 422. Such a frame 424 may include a management frame, a data frame, a TXOP sharing (TXS) frame, or a trigger frame, among other examples. Additionally, or alternatively, the AP 102-b may receive one or more frames within the TXOP 422. For example, in association with the frame 424 being a TXS frame or a trigger frame, the AP 102-b may receive one or more frames associated with (such as responsive to) the frame 424.

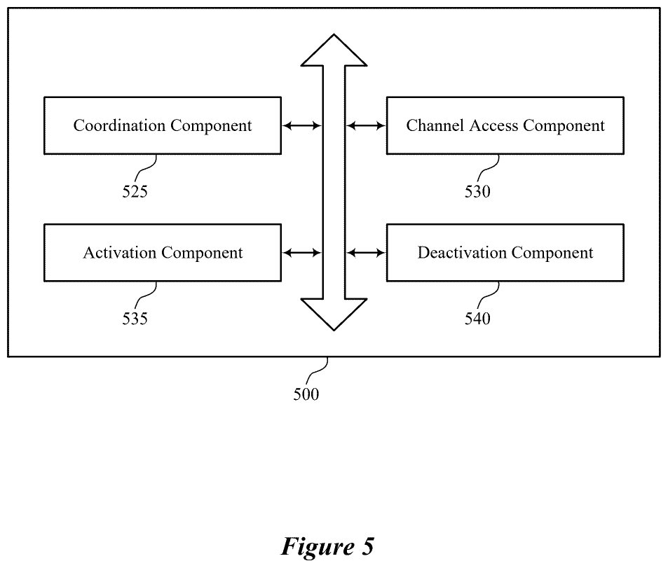

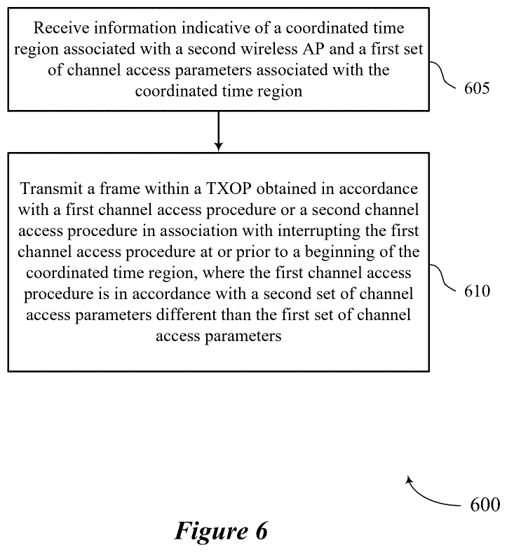

FIG. 5 shows a block diagram of an example wireless communication device 500 that supports coordinated channel access between wireless APs. In some examples, the wireless communication device 500 is configured to perform the processes 600, 700, 800, and 900 described with reference to FIGS. 6, 7, 8, and 9, respectively. The wireless communication device 500 may include one or more chips, SoCs, chipsets, packages, components or devices that individually or collectively constitute or include a processing system. The processing system may interface with other components of the wireless communication device 500, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 500 may transmit the information output from the chip. In such an example, the second interface may refer to an interface between the processing system of the chip and a reception component, such that the wireless communication device 500 may receive information that is then passed to the processing system. In some such examples, the first interface also may obtain information, such as from the transmission component, and the second interface also may output information, such as to the reception component.

The processing system of the wireless communication device 500 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein.

The processing system may further include memory circuitry in the form of one or more memory devices, memory blocks, memory elements or other discrete gate or transistor logic or circuitry, each of which may include tangible storage media such as random-access memory (RAM) or read-only memory (ROM,) or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein.

Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 500 can be configurable or configured for use in an AP, such as the AP 102 described with reference to FIG. 1. In some other examples, the wireless communication device 500 can be an AP that includes such a processing system and other components including multiple antennas. The wireless communication device 500 is capable of transmitting and receiving wireless communications in the form of, for example, wireless packets. For example, the wireless communication device 500 can be configurable or configured to transmit and receive packets in the form of physical layer PPDUs and MPDUs conforming to one or more of the IEEE 802.11 family of wireless communication protocol standards. In some other examples, the wireless communication device 500 can be configurable or configured to transmit and receive signals and communications conforming to one or more 3GPP specifications including those for 5G NR or 6G. In some examples, the wireless communication device 500 also includes or can be coupled with one or more application processors which may be further coupled with one or more other memories. In some examples, the wireless communication device 500 further includes at least one external network interface coupled with the processing system that enables communication with a core network or backhaul network that enables the wireless communication device 500 to gain access to external networks including the Internet.

The wireless communication device 500 includes a coordination component 525, a channel access component 530, an activation component 535, and a deactivation component 540. Portions of one or more of the coordination component 525, the channel access component 530, the activation component 535, and the deactivation component 540 may be implemented at least in part in hardware or firmware. For example, one or more of the coordination component 525, the channel access component 530, the activation component 535, and the deactivation component 540 may be implemented at least in part by at least a processor or a modem. In some examples, portions of one or more of the coordination component 525, the channel access component 530, the activation component 535, and the deactivation component 540 may be implemented at least in part by a processor and software in the form of processor-executable code stored in memory.

The wireless communication device 500 may support wireless communication in accordance with examples as disclosed herein. The coordination component 525 is configurable or configured to receive information indicative of a coordinated time region associated with a second wireless AP and a first set of channel access parameters associated with the coordinated time region. The channel access component 530 is configurable or configured to transmit a frame within a TXOP obtained in accordance with a first channel access procedure or a second channel access procedure in association with interrupting the first channel access procedure at or prior to a beginning of the coordinated time region, where the first channel access procedure is in accordance with a second set of channel access parameters different than the first set of channel access parameters.

In some examples, the channel access component 530 is configurable or configured to initiate the first channel access procedure in accordance with the second set of channel access parameters prior to the beginning of the coordinated time region, where interrupting the first channel access procedure at or prior to the beginning of the coordinated time region is in association with initiating the first channel access procedure in accordance with the second set of channel access parameters prior to the beginning of the coordinated time region and the coordinated time region being associated with the first set of channel access parameters.

In some examples, the first wireless AP classifies the beginning of the coordinated time region as a channel busy event and interrupts the first channel access procedure at or prior to the beginning of the coordinated time region in association with classifying the beginning of the coordinated time region as the channel busy event. In some examples, interrupting the first channel access procedure includes pausing the first channel access procedure.

In some examples, in accordance with a rule associated with the coordinated time region, the first wireless AP classifies the beginning of the coordinated time region as the channel busy event independent of an energy detection measurement at the beginning of the coordinated time region.

In some examples, the first wireless AP resumes the first channel access procedure within the coordinated time region in association with detecting, within the coordinated time region, an idle channel for a threshold time duration. In some examples, the threshold time duration is associated with the first set of channel access parameters.

In some examples, the first channel access procedure that is resumed within the coordinated time region is associated with a hybrid set of channel access parameters in accordance with a resumption of a backoff value selected in accordance with the second set of channel access parameters and a use of the threshold time duration associated with the first set of channel access parameters.

In some examples, the first wireless AP calculates the threshold time duration in accordance with one or more parameters of the first set of channel access parameters. In some examples, the first set of channel access parameters includes a parameter that indicates the threshold time duration. In some examples, the threshold time duration is associated with an AIFSN indicated by the first set of channel access parameters.

In some examples, the first wireless AP resumes the first channel access procedure after the coordinated time region in association with detecting, within the coordinated time region, an idle channel for a threshold time duration. In some examples, the threshold time duration spans a duration of the coordinated time region.

In some examples, the channel access component 530 is configurable or configured to initiate the second channel access procedure in accordance with the first set of channel access parameters within the coordinated time region in association with interrupting the first channel access procedure at or prior to the beginning of the coordinated time region.

In some examples, the first wireless AP stores a state associated with the first channel access procedure in association with interrupting the first channel access procedure at or prior to the beginning of the coordinated time region. In some examples, interrupting the first channel access procedure includes pausing the first channel access procedure.

In some examples, the first wireless AP resumes the first channel access procedure after the coordinated time region in association with storing the state associated with the first channel access procedure.

In some examples, the first wireless AP maintains a first backoff value associated with communication within a set of coordinated time regions and maintains a second backoff value associated with communication outside of the set of coordinated time regions, the set of coordinated time regions including the coordinated time region associated with the second wireless AP.

In some examples, the first wireless AP discards a state associated with the first channel access procedure in association with interrupting the first channel access procedure at or prior to the beginning of the coordinated time region. In some examples, interrupting the first channel access procedure includes terminating the first channel access procedure.

In some examples, the channel access component 530 is configurable or configured to initiate a third channel access procedure in accordance with the second set of channel access parameters after the coordinated time region in association with discarding the state associated with the first channel access procedure.

In some examples, in accordance with a rule associated with the coordinated time region, the first wireless AP refrains from performing a channel access procedure within at least a portion of the coordinated time region.

In some examples, the first wireless AP resumes the first channel access procedure after at least the portion of the coordinated time region in association with interrupting the first channel access procedure at or prior to the beginning of the coordinated time region in accordance with the rule. In some examples, interrupting the first channel access procedure includes pausing the first channel access procedure.

In some examples, the first wireless AP classifies at least the portion of the coordinated time region as a channel busy event and interrupts the first channel access procedure at or prior to the beginning of the coordinated time region in association with classifying at least the portion of the coordinated time region as the channel busy event. In some examples, interrupting the first channel access procedure includes pausing the first channel access procedure.

In some examples, in accordance with the rule associated with the coordinated time region, the first wireless AP classifies the portion of the coordinated time region as the channel busy event independent of one or more energy detection measurements within the portion of the coordinated time region.

In some examples, in accordance with the rule associated with the coordinated time region, the first wireless AP classifies an entirety of the coordinated time region as the channel busy event independent of one or more energy detection measurements within the entirety of the coordinated time region.

In some examples, the coordination component 525 is configurable or configured to receive, via the information or via one or more frames associated with a negotiation between the first wireless AP and the second wireless AP, an indication of a duration of the portion of the coordinated time region.

In some examples, the first wireless AP discards a state associated with the first channel access procedure in association with interrupting the first channel access procedure at or prior to the beginning of the coordinated time region in accordance with the rule. In some examples, interrupting the first channel access procedure includes terminating the first channel access procedure.

In some examples, the channel access component 530 is configurable or configured to initiate the second channel access procedure in accordance with the second set of channel access parameters or the first set of channel access parameters after at least the portion of the coordinated time region in association with discarding the state associated with the first channel access procedure.

In some examples, the first wireless AP initiates the second channel access procedure in accordance with the second set of channel access parameters after the coordinated time region in association with classifying an entirety of the coordinated time region as a channel busy event. In some examples, the first wireless AP initiates the second channel access procedure in accordance with the first set of channel access parameters within the coordinated time region in association with classifying the portion of the coordinated time region as the channel busy event.

In some examples, the activation component 535 is configurable or configured to activate, in association with receiving the information, the first set of channel access parameters for any channel access procedures initiated within the coordinated time region. In some examples, the deactivation component 540 is configurable or configured to deactivate the first set of channel access parameters in accordance with a satisfaction of one or more conditions associated with the coordinated time region.

In some examples, the satisfaction of the one or more conditions includes one or more of the first wireless AP obtaining a first threshold quantity of channel accesses; the second wireless AP obtaining a second threshold quantity of channel accesses; an expiration of the coordinated time region in accordance with a start time and a duration of the coordinated time region; the first wireless AP detecting a threshold quantity of channel busy events within the coordinated time region; or a start of a second coordinated time region of a third wireless AP.

In some examples, the coordination component 525 is configurable or configured to receive, via the information or via one or more frames associated with a negotiation between the first wireless AP and the second wireless AP, an indication of one or more of the first threshold quantity of channel accesses; the second threshold quantity of channel accesses; the start time and the duration of the coordinated time region; or the threshold quantity of channel busy events.

In some examples, the first set of channel access parameters includes a first set of EDCA parameters. In some examples, the second set of channel access parameters includes a second set of EDCA parameters. In some examples, the first wireless AP receives the information from the second wireless AP via one or more management frames. In some examples, the first wireless AP receives the information from a central controller via a backhaul link.

In some examples, the coordination component 525 is configurable or configured to interrupt the first channel access procedure at or prior to the beginning of the coordinated time region in accordance with the first channel access procedure being in accordance with the second set of channel access parameters and the coordinated time region being associated with the first set of channel access parameters. In some examples, the coordinated time region includes a C-rTWT SP or a CLI.

FIG. 6 shows a flowchart illustrating an example process 600 performable by or at a first wireless AP that supports coordinated channel access between wireless APs. The operations of the process 600 may be implemented by a first wireless AP or its components as described herein. For example, the process 600 may be performed by a wireless communication device, such as the wireless communication device 500 described with reference to FIG. 5, operating as or within a wireless AP. In some examples, the process 600 may be performed by a wireless AP, such as one of the APs 102 described with reference to FIG. 1.

In some examples, in 605, the first wireless AP may receive information indicative of a coordinated time region associated with a second wireless AP and a first set of channel access parameters associated with the coordinated time region. The operations of 605 may be performed in accordance with examples as disclosed herein. In some implementations, aspects of the operations of 605 may be performed by a coordination component 525 as described with reference to FIG. 5.

In some examples, in 610, the first wireless AP may transmit a frame within a TXOP obtained in accordance with a first channel access procedure or a second channel access procedure in association with interrupting the first channel access procedure at or prior to a beginning of the coordinated time region, where the first channel access procedure is in accordance with a second set of channel access parameters different than the first set of channel access parameters. The operations of 610 may be performed in accordance with examples as disclosed herein. In some implementations, aspects of the operations of 610 may be performed by a channel access component 530 as described with reference to FIG. 5.

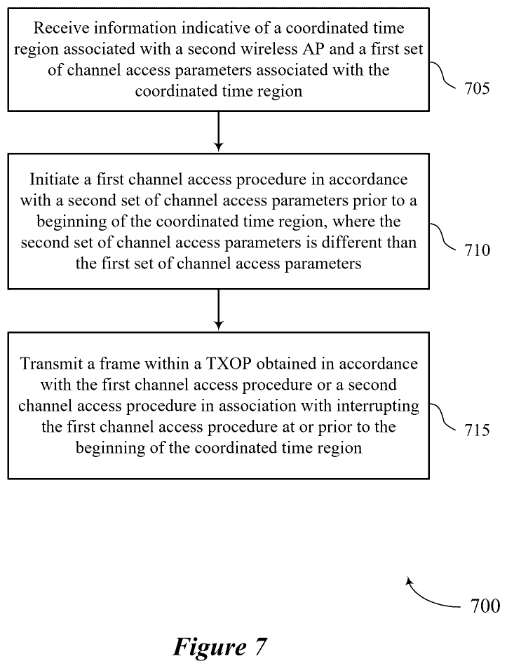

FIG. 7 shows a flowchart illustrating an example process 700 performable by or at a first wireless AP that supports coordinated channel access between wireless APs. The operations of the process 700 may be implemented by a first wireless AP or its components as described herein. For example, the process 700 may be performed by a wireless communication device, such as the wireless communication device 500 described with reference to FIG. 5, operating as or within a wireless AP. In some examples, the process 700 may be performed by a wireless AP, such as one of the APs 102 described with reference to FIG. 1.

In some examples, in 705, the first wireless AP may receive information indicative of a coordinated time region associated with a second wireless AP and a first set of channel access parameters associated with the coordinated time region. The operations of 705 may be performed in accordance with examples as disclosed herein. In some implementations, aspects of the operations of 705 may be performed by a coordination component 525 as described with reference to FIG. 5.

In some examples, in 710, the first wireless AP may initiate a first channel access procedure in accordance with a second set of channel access parameters prior to a beginning of the coordinated time region, where the second set of channel access parameters is different than the first set of channel access parameters. The operations of 710 may be performed in accordance with examples as disclosed herein. In some implementations, aspects of the operations of 710 may be performed by a channel access component 530 as described with reference to FIG. 5.

In some examples, in 715, the first wireless AP may transmit a frame within a TXOP obtained in accordance with the first channel access procedure or a second channel access procedure in association with interrupting the first channel access procedure at or prior to the beginning of the coordinated time region. The operations of 715 may be performed in accordance with examples as disclosed herein. In some implementations, aspects of the operations of 715 may be performed by a channel access component 530 as described with reference to FIG. 5.

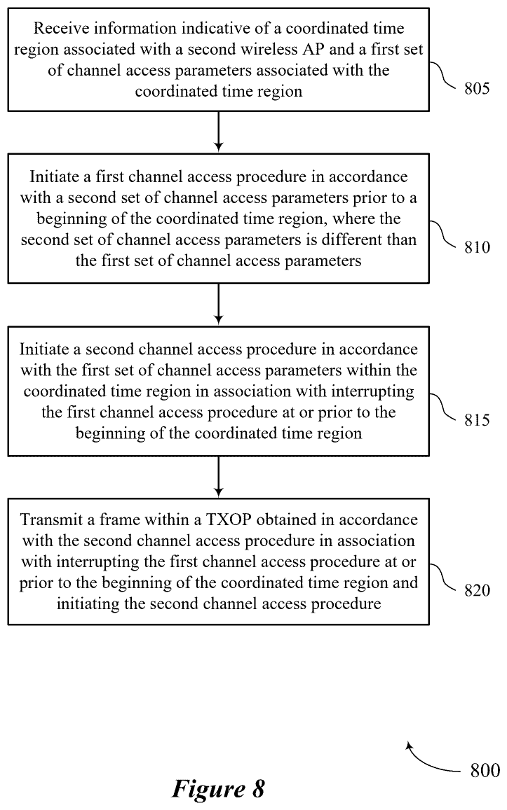

FIG. 8 shows a flowchart illustrating an example process 800 performable by or at a first wireless AP that supports coordinated channel access between wireless APs. The operations of the process 800 may be implemented by a first wireless AP or its components as described herein. For example, the process 800 may be performed by a wireless communication device, such as the wireless communication device 500 described with reference to FIG. 5, operating as or within a wireless AP. In some examples, the process 800 may be performed by a wireless AP, such as one of the APs 102 described with reference to FIG. 1.

In some examples, in 805, the first wireless AP may receive information indicative of a coordinated time region associated with a second wireless AP and a first set of channel access parameters associated with the coordinated time region. The operations of 805 may be performed in accordance with examples as disclosed herein. In some implementations, aspects of the operations of 805 may be performed by a coordination component 525 as described with reference to FIG. 5.

In some examples, in 810, the first wireless AP may initiate a first channel access procedure in accordance with a second set of channel access parameters prior to a beginning of the coordinated time region, where the second set of channel access parameters is different than the first set of channel access parameters. The operations of 810 may be performed in accordance with examples as disclosed herein. In some implementations, aspects of the operations of 810 may be performed by a channel access component 530 as described with reference to FIG. 5.

In some examples, in 815, the first wireless AP may initiate a second channel access procedure in accordance with the first set of channel access parameters within the coordinated time region in association with interrupting the first channel access procedure at or prior to the beginning of the coordinated time region. The operations of 815 may be performed in accordance with examples as disclosed herein. In some implementations, aspects of the operations of 815 may be performed by a channel access component 530 as described with reference to FIG. 5.

In some examples, in 820, the first wireless AP may transmit a frame within a TXOP obtained in accordance with the second channel access procedure in association with interrupting the first channel access procedure at or prior to the beginning of the coordinated time region and initiating the second channel access procedure. The operations of 820 may be performed in accordance with examples as disclosed herein. In some implementations, aspects of the operations of 820 may be performed by a channel access component 530 as described with reference to FIG. 5.

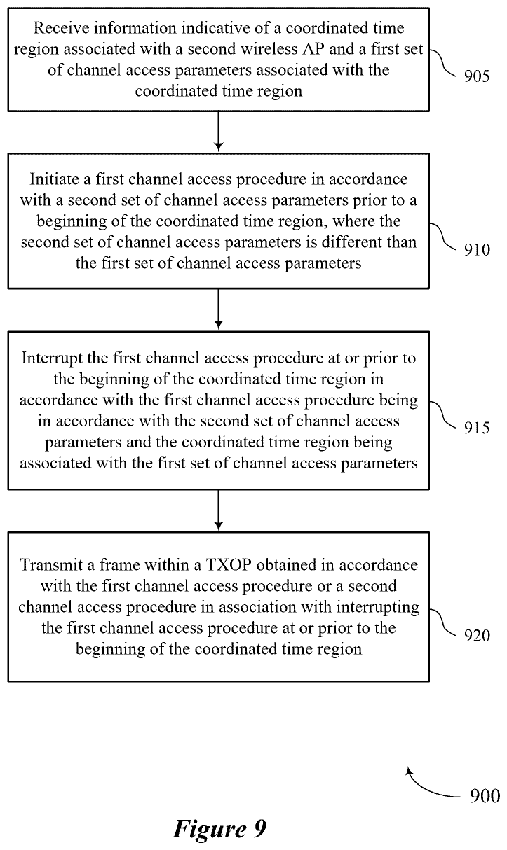

FIG. 9 shows a flowchart illustrating an example process 900 performable by or at a first wireless AP that supports coordinated channel access between wireless APs. The operations of the process 900 may be implemented by a first wireless AP or its components as described herein. For example, the process 900 may be performed by a wireless communication device, such as the wireless communication device 500 described with reference to FIG. 5, operating as or within a wireless AP. In some examples, the process 900 may be performed by a wireless AP, such as one of the APs 102 described with reference to FIG. 1.

In some examples, in 905, the first wireless AP may receive information indicative of a coordinated time region associated with a second wireless AP and a first set of channel access parameters associated with the coordinated time region. The operations of 905 may be performed in accordance with examples as disclosed herein. In some implementations, aspects of the operations of 905 may be performed by a coordination component 525 as described with reference to FIG. 5.

In some examples, in 910, the first wireless AP may initiate a first channel access procedure in accordance with a second set of channel access parameters prior to a beginning of the coordinated time region, where the second set of channel access parameters is different than the first set of channel access parameters. The operations of 910 may be performed in accordance with examples as disclosed herein. In some implementations, aspects of the operations of 910 may be performed by a channel access component 530 as described with reference to FIG. 5.

In some examples, in 915, the first wireless AP may interrupt the first channel access procedure at or prior to the beginning of the coordinated time region in accordance with the first channel access procedure being in accordance with the second set of channel access parameters and the coordinated time region being associated with the first set of channel access parameters. The operations of 915 may be performed in accordance with examples as disclosed herein. In some implementations, aspects of the operations of 915 may be performed by a coordination component 525 as described with reference to FIG. 5.

In some examples, in 920, the first wireless AP may transmit a frame within a TXOP obtained in accordance with the first channel access procedure or a second channel access procedure in association with interrupting the first channel access procedure at or prior to the beginning of the coordinated time region. The operations of 920 may be performed in accordance with examples as disclosed herein. In some implementations, aspects of the operations of 920 may be performed by a channel access component 530 as described with reference to FIG. 5.

Implementation examples are described in the following numbered clauses:

Clause 1: A method for wireless communication at a first wireless AP, including: receiving information indicative of a coordinated time region associated with a second wireless AP and a first set of channel access parameters associated with the coordinated time region; and transmitting a frame within a TXOP obtained in accordance with a first channel access procedure or a second channel access procedure in association with interrupting the first channel access procedure at or prior to a beginning of the coordinated time region, where the first channel access procedure is in accordance with a second set of channel access parameters different than the first set of channel access parameters.

Clause 2: The method of clause 1, further including: initiating the first channel access procedure in accordance with the second set of channel access parameters prior to the beginning of the coordinated time region, where interrupting the first channel access procedure at or prior to the beginning of the coordinated time region is in association with initiating the first channel access procedure in accordance with the second set of channel access parameters prior to the beginning of the coordinated time region and the coordinated time region being associated with the first set of channel access parameters.

Clause 3: The method of any of clauses 1-2, where the first wireless AP classifies the beginning of the coordinated time region as a channel busy event and interrupts the first channel access procedure at or prior to the beginning of the coordinated time region in association with classifying the beginning of the coordinated time region as the channel busy event, interrupting the first channel access procedure includes pausing the first channel access procedure.

Clause 4: The method of clause 3, where in accordance with a rule associated with the coordinated time region, the first wireless AP classifies the beginning of the coordinated time region as the channel busy event independent of an energy detection measurement at the beginning of the coordinated time region.

Clause 5: The method of any of clauses 3-4, where the first wireless AP resumes the first channel access procedure within the coordinated time region in association with detecting, within the coordinated time region, an idle channel for a threshold time duration; and the threshold time duration is associated with the first set of channel access parameters.

Clause 6: The method of clause 5, where the first channel access procedure that is resumed within the coordinated time region is associated with a hybrid set of channel access parameters in accordance with a resumption of a backoff value selected in accordance with the second set of channel access parameters and a use of the threshold time duration associated with the first set of channel access parameters.

Clause 7: The method of any of clauses 5-6, where the first wireless AP calculates the threshold time duration in accordance with one or more parameters of the first set of channel access parameters.

Clause 8: The method of any of clauses 5-7, where the first set of channel access parameters includes a parameter that indicates the threshold time duration.

Clause 9: The method of any of clauses 5-8, where the threshold time duration is associated with an AIFSN indicated by the first set of channel access parameters.

Clause 10: The method of any of clauses 3-9, where the first wireless AP resumes the first channel access procedure after the coordinated time region in association with detecting, within the coordinated time region, an idle channel for a threshold time duration; and the threshold time duration spans a duration of the coordinated time region.

Clause 11: The method of any of clauses 1-10, further including: initiating the second channel access procedure in accordance with the first set of channel access parameters within the coordinated time region in association with interrupting the first channel access procedure at or prior to the beginning of the coordinated time region.

Clause 12: The method of clause 11, where the first wireless AP stores a state associated with the first channel access procedure in association with interrupting the first channel access procedure at or prior to the beginning of the coordinated time region, interrupting the first channel access procedure includes pausing the first channel access procedure.

Clause 13: The method of clause 12, where the first wireless AP resumes the first channel access procedure after the coordinated time region in association with storing the state associated with the first channel access procedure.

Clause 14: The method of any of clauses 12-13, where the first wireless AP maintains a first backoff value associated with communication within a set of coordinated time regions and maintains a second backoff value associated with communication outside of the set of coordinated time regions, the set of coordinated time regions including the coordinated time region associated with the second wireless AP.

Clause 15: The method of any of clauses 11-14, where the first wireless AP discards a state associated with the first channel access procedure in association with interrupting the first channel access procedure at or prior to the beginning of the coordinated time region, interrupting the first channel access procedure includes terminating the first channel access procedure.

Clause 16: The method of clause 15, further including: initiating a third channel access procedure in accordance with the second set of channel access parameters after the coordinated time region in association with discarding the state associated with the first channel access procedure.

Clause 17: The method of any of clauses 1-16, where in accordance with a rule associated with the coordinated time region, the first wireless AP refrains from performing a channel access procedure within at least a portion of the coordinated time region.

Clause 18: The method of clause 17, where the first wireless AP resumes the first channel access procedure after at least the portion of the coordinated time region in association with interrupting the first channel access procedure at or prior to the beginning of the coordinated time region in accordance with the rule, interrupting the first channel access procedure includes pausing the first channel access procedure.

Clause 19: The method of any of clauses 17-18, where the first wireless AP classifies at least the portion of the coordinated time region as a channel busy event and interrupts the first channel access procedure at or prior to the beginning of the coordinated time region in association with classifying at least the portion of the coordinated time region as the channel busy event, interrupting the first channel access procedure includes pausing the first channel access procedure.

Clause 20: The method of clause 19, where in accordance with the rule associated with the coordinated time region, the first wireless AP classifies the portion of the coordinated time region as the channel busy event independent of one or more energy detection measurements within the portion of the coordinated time region.

Clause 21: The method of any of clauses 19-20, where in accordance with the rule associated with the coordinated time region, the first wireless AP classifies an entirety of the coordinated time region as the channel busy event independent of one or more energy detection measurements within the entirety of the coordinated time region.

Clause 22: The method of any of clauses 19-21, further including: receiving, via the information or via one or more frames associated with a negotiation between the first wireless AP and the second wireless AP, an indication of a duration of the portion of the coordinated time region.

Clause 23: The method of any of clauses 17-22, where the first wireless AP discards a state associated with the first channel access procedure in association with interrupting the first channel access procedure at or prior to the beginning of the coordinated time region in accordance with the rule, interrupting the first channel access procedure includes terminating the first channel access procedure.

Clause 24: The method of clause 23, further including: initiating the second channel access procedure in accordance with the second set of channel access parameters or the first set of channel access parameters after at least the portion of the coordinated time region in association with discarding the state associated with the first channel access procedure.

Clause 25: The method of clause 24, where the first wireless AP initiates the second channel access procedure in accordance with the second set of channel access parameters after the coordinated time region in association with classifying an entirety of the coordinated time region as a channel busy event; or the first wireless AP initiates the second channel access procedure in accordance with the first set of channel access parameters within the coordinated time region in association with classifying the portion of the coordinated time region as the channel busy event.

Clause 26: The method of any of clauses 1-25, further including: activating, in association with receiving the information, the first set of channel access parameters for any channel access procedures initiated within the coordinated time region; and deactivating the first set of channel access parameters in accordance with a satisfaction of one or more conditions associated with the coordinated time region.

Clause 27: The method of clause 26, where the satisfaction of the one or more conditions includes one or more of the first wireless AP obtaining a first threshold quantity of channel accesses; the second wireless AP obtaining a second threshold quantity of channel accesses; an expiration of the coordinated time region in accordance with a start time and a duration of the coordinated time region; the first wireless AP detecting a threshold quantity of channel busy events within the coordinated time region; or a start of a second coordinated time region of a third wireless AP.

Clause 28: The method of clause 27, further including: receiving, via the information or via one or more frames associated with a negotiation between the first wireless AP and the second wireless AP, an indication of one or more of the first threshold quantity of channel accesses; the second threshold quantity of channel accesses; the start time and the duration of the coordinated time region; or the threshold quantity of channel busy events.

Clause 29: The method of any of clauses 1-28, where the first set of channel access parameters includes a first set of EDCA parameters, and the second set of channel access parameters includes a second set of EDCA parameters.

Clause 30: The method of any of clauses 1-29, where the first wireless AP receives the information from the second wireless AP via one or more management frames.

Clause 31: The method of any of clauses 1-30, where the first wireless AP receives the information from a central controller via a backhaul link.

Clause 32: The method of any of clauses 1-31, further including: interrupting the first channel access procedure at or prior to the beginning of the coordinated time region in accordance with the first channel access procedure being in accordance with the second set of channel access parameters and the coordinated time region being associated with the first set of channel access parameters.

Clause 33: The method of any of clauses 1-32, where the coordinated time region includes a C-rTWT SP or a CLI.

Clause 34: A first wireless AP, including: a processing system that includes processor circuitry and memory circuitry that stores code, the processing system configured to cause the first wireless AP to: receive information indicative of a coordinated time region associated with a second wireless AP and a first set of channel access parameters associated with the coordinated time region; and transmit a frame within a TXOP obtained in accordance with a first channel access procedure or a second channel access procedure in association with interrupting the first channel access procedure at or prior to a beginning of the coordinated time region, where the first channel access procedure is in accordance with a second set of channel access parameters different than the first set of channel access parameters.

Clause 35: The first wireless AP of clause 34, where the processing system is further configured to cause the first wireless AP to: initiate the first channel access procedure in accordance with the second set of channel access parameters prior to the beginning of the coordinated time region, where interrupting the first channel access procedure at or prior to the beginning of the coordinated time region is in association with initiating the first channel access procedure in accordance with the second set of channel access parameters prior to the beginning of the coordinated time region and the coordinated time region being associated with the first set of channel access parameters.

Clause 36: The first wireless AP of any of clauses 34-35, where the first wireless AP classifies the beginning of the coordinated time region as a channel busy event and interrupts the first channel access procedure at or prior to the beginning of the coordinated time region in association with classifying the beginning of the coordinated time region as the channel busy event, interrupting the first channel access procedure includes pausing the first channel access procedure.

Clause 37: The first wireless AP of clause 36, where in accordance with a rule associated with the coordinated time region, the first wireless AP classifies the beginning of the coordinated time region as the channel busy event independent of an energy detection measurement at the beginning of the coordinated time region.

Clause 38: The first wireless AP of any of clauses 36-37, where the first wireless AP resumes the first channel access procedure within the coordinated time region in association with detecting, within the coordinated time region, an idle channel for a threshold time duration; and the threshold time duration is associated with the first set of channel access parameters.

Clause 39: The first wireless AP of clause 38, where the first channel access procedure that is resumed within the coordinated time region is associated with a hybrid set of channel access parameters in accordance with a resumption of a backoff value selected in accordance with the second set of channel access parameters and a use of the threshold time duration associated with the first set of channel access parameters.

Clause 40: The first wireless AP of any of clauses 38-39, where the first wireless AP calculates the threshold time duration in accordance with one or more parameters of the first set of channel access parameters.

Clause 41: The first wireless AP of any of clauses 38-40, where the first set of channel access parameters includes a parameter that indicates the threshold time duration.

Clause 42: The first wireless AP of any of clauses 38-41, where the threshold time duration is associated with an AIFSN indicated by the first set of channel access parameters.

Clause 43: The first wireless AP of any of clauses 36-42, where the first wireless AP resumes the first channel access procedure after the coordinated time region in association with detecting, within the coordinated time region, an idle channel for a threshold time duration; and the threshold time duration spans a duration of the coordinated time region.

Clause 44: The first wireless AP of any of clauses 34-43, where the processing system is further configured to cause the first wireless AP to: initiate the second channel access procedure in accordance with the first set of channel access parameters within the coordinated time region in association with interrupting the first channel access procedure at or prior to the beginning of the coordinated time region.

Clause 45: The first wireless AP of clause 44, where the first wireless AP stores a state associated with the first channel access procedure in association with interrupting the first channel access procedure at or prior to the beginning of the coordinated time region, interrupting the first channel access procedure includes pausing the first channel access procedure.

Clause 46: The first wireless AP of clause 45, where the first wireless AP resumes the first channel access procedure after the coordinated time region in association with storing the state associated with the first channel access procedure.

Clause 47: The first wireless AP of any of clauses 45-46, where the first wireless AP maintains a first backoff value associated with communication within a set of coordinated time regions and maintains a second backoff value associated with communication outside of the set of coordinated time regions, the set of coordinated time regions including the coordinated time region associated with the second wireless AP.

Clause 48: The first wireless AP of any of clauses 44-47, where the first wireless AP discards a state associated with the first channel access procedure in association with interrupting the first channel access procedure at or prior to the beginning of the coordinated time region, interrupting the first channel access procedure includes terminating the first channel access procedure.

Clause 49: The first wireless AP of clause 48, where the processing system is further configured to cause the first wireless AP to: initiate a third channel access procedure in accordance with the second set of channel access parameters after the coordinated time region in association with discarding the state associated with the first channel access procedure.

Clause 50: The first wireless AP of any of clauses 34-49, where in accordance with a rule associated with the coordinated time region, the first wireless AP refrains from performing a channel access procedure within at least a portion of the coordinated time region.

Clause 51: The first wireless AP of clause 50, where the first wireless AP resumes the first channel access procedure after at least the portion of the coordinated time region in association with interrupting the first channel access procedure at or prior to the beginning of the coordinated time region in accordance with the rule, interrupting the first channel access procedure includes pausing the first channel access procedure.

Clause 52: The first wireless AP of any of clauses 50-51, where the first wireless AP classifies at least the portion of the coordinated time region as a channel busy event and interrupts the first channel access procedure at or prior to the beginning of the coordinated time region in association with classifying at least the portion of the coordinated time region as the channel busy event, interrupting the first channel access procedure includes pausing the first channel access procedure.

Clause 53: The first wireless AP of clause 52, where in accordance with the rule associated with the coordinated time region, the first wireless AP classifies the portion of the coordinated time region as the channel busy event independent of one or more energy detection measurements within the portion of the coordinated time region.

Clause 54: The first wireless AP of any of clauses 52-53, where in accordance with the rule associated with the coordinated time region, the first wireless AP classifies an entirety of the coordinated time region as the channel busy event independent of one or more energy detection measurements within the entirety of the coordinated time region.

Clause 55: The first wireless AP of any of clauses 52-54, where the processing system is further configured to cause the first wireless AP to: receive, via the information or via one or more frames associated with a negotiation between the first wireless AP and the second wireless AP, an indication of a duration of the portion of the coordinated time region.

Clause 56: The first wireless AP of any of clauses 50-55, where the first wireless AP discards a state associated with the first channel access procedure in association with interrupting the first channel access procedure at or prior to the beginning of the coordinated time region in accordance with the rule, interrupting the first channel access procedure includes terminating the first channel access procedure.

Clause 57: The first wireless AP of clause 56, where the processing system is further configured to cause the first wireless AP to: initiate the second channel access procedure in accordance with the second set of channel access parameters or the first set of channel access parameters after at least the portion of the coordinated time region in association with discarding the state associated with the first channel access procedure.

Clause 58: The first wireless AP of clause 57, where the first wireless AP initiates the second channel access procedure in accordance with the second set of channel access parameters after the coordinated time region in association with classifying an entirety of the coordinated time region as a channel busy event; or the first wireless AP initiates the second channel access procedure in accordance with the first set of channel access parameters within the coordinated time region in association with classifying the portion of the coordinated time region as the channel busy event.

Clause 59: The first wireless AP of any of clauses 34-58, where the processing system is further configured to cause the first wireless AP to: activate, in association with receiving the information, the first set of channel access parameters for any channel access procedures initiated within the coordinated time region; and deactivate the first set of channel access parameters in accordance with a satisfaction of one or more conditions associated with the coordinated time region.

Clause 60: The first wireless AP of clause 59, where the satisfaction of the one or more conditions includes one or more of the first wireless AP obtaining a first threshold quantity of channel accesses; the second wireless AP obtaining a second threshold quantity of channel accesses; an expiration of the coordinated time region in accordance with a start time and a duration of the coordinated time region; the first wireless AP detecting a threshold quantity of channel busy events within the coordinated time region; or a start of a second coordinated time region of a third wireless AP.

Clause 61: The first wireless AP of clause 60, where the processing system is further configured to cause the first wireless AP to: receive, via the information or via one or more frames associated with a negotiation between the first wireless AP and the second wireless AP, an indication of one or more of the first threshold quantity of channel accesses; the second threshold quantity of channel accesses; the start time and the duration of the coordinated time region; or the threshold quantity of channel busy events.

Clause 62: The first wireless AP of any of clauses 34-61, where the first set of channel access parameters includes a first set of EDCA parameters, and the second set of channel access parameters includes a second set of EDCA parameters.

Clause 63: The first wireless AP of any of clauses 34-62, where the first wireless AP receives the information from the second wireless AP via one or more management frames.

Clause 64: The first wireless AP of any of clauses 34-63, where the first wireless AP receives the information from a central controller via a backhaul link.

Clause 65: The first wireless AP of any of clauses 34-64, where the processing system is further configured to cause the first wireless AP to: interrupt the first channel access procedure at or prior to the beginning of the coordinated time region in accordance with the first channel access procedure being in accordance with the second set of channel access parameters and the coordinated time region being associated with the first set of channel access parameters.

Clause 66: The first wireless AP of any of clauses 34-65, where the coordinated time region includes a C-rTWT SP or a CLI.

Clause 67: A first wireless AP, including at least one means for performing a method of any of aspects 1-33.

Clause 68: A non-transitory computer-readable medium storing code for wireless communication, the code including instructions executable by a processing system (such as one or more processors) to perform a method of any of aspects 1-33.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. A first wireless access point (AP), comprising:
a processing system that includes processor circuitry and memory circuitry that stores code, the processing system configured to cause the first wireless AP to:
receive information indicative of:
a coordinated time region associated with a second wireless AP, and
a first set of channel access parameters associated with the coordinated time region; and
transmit a frame within a transmission opportunity (TXOP) obtained in accordance with a first channel access procedure or a second channel access procedure in association with interrupting the first channel access procedure at or prior to a beginning of the coordinated time region, wherein the first channel access procedure is in accordance with a second set of channel access parameters different than the first set of channel access parameters.

2. The first wireless AP of claim 1, wherein the processing system is further configured to cause the first wireless AP to:
initiate the first channel access procedure in accordance with the second set of channel access parameters prior to the beginning of the coordinated time region, wherein interrupting the first channel access procedure at or prior to the beginning of the coordinated time region is in association with:
initiating the first channel access procedure in accordance with the second set of channel access parameters prior to the beginning of the coordinated time region; and
the coordinated time region being associated with the first set of channel access parameters.

3. The first wireless AP of claim 1, wherein:
the first wireless AP classifies the beginning of the coordinated time region as a channel busy event and interrupts the first channel access procedure at or prior to the beginning of the coordinated time region in association with classifying the beginning of the coordinated time region as the channel busy event; and
interrupting the first channel access procedure comprises pausing the first channel access procedure.

4. The first wireless AP of claim 3, wherein in accordance with a rule associated with the coordinated time region, the first wireless AP classifies the beginning of the coordinated time region as the channel busy event independent of an energy detection measurement at the beginning of the coordinated time region.

5. The first wireless AP of claim 3, wherein:
the first wireless AP resumes the first channel access procedure within the coordinated time region in association with detecting, within the coordinated time region, an idle channel for a threshold time duration; and
the threshold time duration is associated with the first set of channel access parameters.

6. The first wireless AP of claim 5, wherein the first channel access procedure that is resumed within the coordinated time region is associated with a hybrid set of channel access parameters in accordance with:
a resumption of a backoff value selected in accordance with the second set of channel access parameters; and
a use of the threshold time duration associated with the first set of channel access parameters.

7-9. (canceled)

10. The first wireless AP of claim 3, wherein:
the first wireless AP resumes the first channel access procedure after the coordinated time region in association with detecting, within the coordinated time region, an idle channel for a threshold time duration; and
the threshold time duration spans a duration of the coordinated time region.

11. The first wireless AP of claim 1, wherein the processing system is further configured to cause the first wireless AP to:
initiate the second channel access procedure in accordance with the first set of channel access parameters within the coordinated time region in association with interrupting the first channel access procedure at or prior to the beginning of the coordinated time region.

12. The first wireless AP of claim 11, wherein:
the first wireless AP stores a state associated with the first channel access procedure in association with interrupting the first channel access procedure at or prior to the beginning of the coordinated time region; and
interrupting the first channel access procedure comprises pausing the first channel access procedure.

13. The first wireless AP of claim 12, wherein the first wireless AP resumes the first channel access procedure after the coordinated time region in association with storing the state associated with the first channel access procedure.

14. (canceled)

15. The first wireless AP of claim 11, wherein:
the first wireless AP discards a state associated with the first channel access procedure in association with interrupting the first channel access procedure at or prior to the beginning of the coordinated time region; and
interrupting the first channel access procedure comprises terminating the first channel access procedure.

16. The first wireless AP of claim 15, wherein the processing system is further configured to cause the first wireless AP to:
initiate a third channel access procedure in accordance with the second set of channel access parameters after the coordinated time region in association with discarding the state associated with the first channel access procedure.

17. The first wireless AP of claim 1, wherein, in accordance with a rule associated with the coordinated time region, the first wireless AP refrains from performing a channel access procedure within at least a portion of the coordinated time region.

18. The first wireless AP of claim 17, wherein:
the first wireless AP resumes the first channel access procedure after at least the portion of the coordinated time region in association with interrupting the first channel access procedure at or prior to the beginning of the coordinated time region in accordance with the rule; and
interrupting the first channel access procedure comprises pausing the first channel access procedure.

19. The first wireless AP of claim 17, wherein:
the first wireless AP classifies at least the portion of the coordinated time region as a channel busy event and interrupts the first channel access procedure at or prior to the beginning of the coordinated time region in association with classifying at least the portion of the coordinated time region as the channel busy event; and
interrupting the first channel access procedure comprises pausing the first channel access procedure.

20. The first wireless AP of claim 19, wherein, in accordance with the rule associated with the coordinated time region, the first wireless AP classifies the portion of the coordinated time region as the channel busy event independent of one or more energy detection measurements within the portion of the coordinated time region.

21. The first wireless AP of claim 19, wherein, in accordance with the rule associated with the coordinated time region, the first wireless AP classifies an entirety of the coordinated time region as the channel busy event independent of one or more energy detection measurements within the entirety of the coordinated time region.

22. The first wireless AP of claim 19, wherein the processing system is further configured to cause the first wireless AP to:
receive, via the information or via one or more frames associated with a negotiation between the first wireless AP and the second wireless AP, an indication of a duration of the portion of the coordinated time region.

23. The first wireless AP of claim 17, wherein:
the first wireless AP discards a state associated with the first channel access procedure in association with interrupting the first channel access procedure at or prior to the beginning of the coordinated time region in accordance with the rule; and
interrupting the first channel access procedure comprises terminating the first channel access procedure.

24. The first wireless AP of claim 23, wherein the processing system is further configured to cause the first wireless AP to:
initiate the second channel access procedure in accordance with the second set of channel access parameters or the first set of channel access parameters after at least the portion of the coordinated time region in association with discarding the state associated with the first channel access procedure.

25-33. (canceled)

34. A method for wireless communication at a first wireless access point (AP), comprising:
receiving information indicative of a coordinated time region associated with a second wireless AP and a first set of channel access parameters associated with the coordinated time region; and
transmitting a frame within a transmission opportunity (TXOP) obtained in accordance with a first channel access procedure or a second channel access procedure in association with interrupting the first channel access procedure at or prior to a beginning of the coordinated time region, wherein the first channel access procedure is in accordance with a second set of channel access parameters different than the first set of channel access parameters.

35. The method of claim 34, further comprising:
initiating the first channel access procedure in accordance with the second set of channel access parameters prior to the beginning of the coordinated time region, wherein interrupting the first channel access procedure at or prior to the beginning of the coordinated time region is in association with:
initiating the first channel access procedure in accordance with the second set of channel access parameters prior to the beginning of the coordinated time region; and
the coordinated time region being associated with the first set of channel access parameters.

36. The method of claim 34, wherein:
the first wireless AP classifies the beginning of the coordinated time region as a channel busy event and interrupts the first channel access procedure at or prior to the beginning of the coordinated time region in association with classifying the beginning of the coordinated time region as the channel busy event; and
interrupting the first channel access procedure comprises pausing the first channel access procedure.

37-43. (canceled)

44. The method of claim 34, further comprising:
initiating the second channel access procedure in accordance with the first set of channel access parameters within the coordinated time region in association with interrupting the first channel access procedure at or prior to the beginning of the coordinated time region.

45-49. (canceled)

50. The method of claim 34, wherein in accordance with a rule associated with the coordinated time region, the first wireless AP refrains from performing a channel access procedure within at least a portion of the coordinated time region.

51-58. (canceled)

59. The method of claim 34, further comprising:
activating, in association with receiving the information, the first set of channel access parameters for any channel access procedures initiated within the coordinated time region; and
deactivating the first set of channel access parameters in accordance with a satisfaction of one or more conditions associated with the coordinated time region.

60. The method of claim 59, wherein the satisfaction of the one or more conditions comprises one or more of:
the first wireless AP obtaining a first threshold quantity of channel accesses;
the second wireless AP obtaining a second threshold quantity of channel accesses;
an expiration of the coordinated time region in accordance with a start time and a duration of the coordinated time region;
the first wireless AP detecting a threshold quantity of channel busy events within the coordinated time region; or
a start of a second coordinated time region of a third wireless AP.

61. The method of claim 60, further comprising:
receiving, via the information or via one or more frames associated with a negotiation between the first wireless AP and the second wireless AP, an indication of:
one or more of the first threshold quantity of channel accesses;
the second threshold quantity of channel accesses;
the start time and the duration of the coordinated time region; or
the threshold quantity of channel busy events.

62. (canceled)

63. The method of claim 34, wherein the first wireless AP receives the information from the second wireless AP via one or more management frames.

64. The method of claim 34, wherein the first wireless AP receives the information from a central controller via a backhaul link.

65. (canceled)

66. (canceled)
